(19) United States
(12) Patent Application Publication
(10) Pub. No.: US 2019/0315969 A1
(43) Pub. Date: Oct. 17, 2019

(54) High Temperature Boron Black Ceramic Additives, Pigments, and Formulations

(71) Applicant: Melior Innovations, Inc., Houston, TX (US)

(72) Inventors: Wen Liao, Clifton Park, NY (US); Douglas Dukes, Troy, NY (US); Lingyu Li, Niskayuna, NY (US); Richard Landtiser, Naperville, IN (US); Brittney Ivey, Latham, NY (US)

(73) Assignee: Melior Innovations, Inc., Houston, TX (US)

(21) Appl. No.: 15/965,916

(22) Filed: Apr. 28, 2018

Related U.S. Application Data
(60) Provisional application No. 62/492,028, filed on Apr. 28, 2017.

(51) Int. Cl. C09C 1/28

(52) U.S. Cl. CPC C09C 1/28; C01P 2006/60; C01P 2004/80; C01P 2006/37

(57) ABSTRACT

High temperature boron-PDC (polymer derived ceramic) black materials for use as, or in, colorants, inks, pigments, dyes, additives and formulations utilizing these black materials. Boron-PDC materials having boron, silicon, oxygen and carbon, and methods of making these ceramics; formulations utilizing these black ceramics; and devices, structures and apparatus that have or utilize these formulations. Plastics, paints, inks, coatings, formulations, liquids and adhesives containing ceramic black materials, preferably polymer derived boron containing black ceramic materials, and in particular boron-SiOC derived ceramic materials.

This application claims under 35 U.S.C. § 119(e)(1) the benefit of the filing date of U.S. provisional application Ser. No. 62/492,028 filed Apr. 28, 2017, the entire disclosure of which is incorporated herein by reference.

### BACKGROUND OF THE INVENTION

### Field of the Invention

The present inventions relate to black materials and formulations utilizing these materials for high temperature applications, typically for temperatures greater than 400° C. Generally, the present inventions relate to: ceramic materials having blackness, black color, and which are black; starting compositions for these ceramic materials, and methods of making these ceramic materials; and formulations, compositions, materials and devices that utilize or have these ceramic materials.

As used herein, unless stated otherwise, the terms “color,” “colors” “coloring” and similar such terms are be given their broadest possible meaning and would include, among other things, the appearance of the object or material, the color imparted to an object or material by an additive, methods of changing, modifying or affecting color, the reflected refracted and transmitted wavelength(s) of light detected or observed from an object or material, the reflected refracted and transmitted spectrum(s) of light detected or observed from an object or material, all colors, e.g. white, grey, black, red, violet, amber, almond, orange, aquamarine, tan, forest green, etc., primary colors, secondary colors, and all variations between, and the characteristic of light by which any two structure free fields of view of the same size and shape can be distinguish between.

As used herein, unless stated otherwise, the terms “black”, “blackness”, “degree of blackness” and similar such terms, are to be given there broadest possible meanings, and would include among other things, the appearance of an object, color, or material: that is substantially the darkest color owing to the absence, or essential absence of, or absorption, or essential abortion of light; where the reflected refracted and transmitted spectrum(s) of light detected or observed from an object or material has no, substantially no, and essentially no light in the visible wavelengths; the colors that are considered generally black in any color space characterization scheme, including the colors that are considered generally black in L a b color space, the colors that are considered generally black in the Hunter color space, the colors that are considered generally black in the CIE color space, and the colors that are considered generally black in the CIELAB color space; any color, or object or material, that matches or substantially matches any Pantone® color that is referred to as black, including PMS 433, Black 3, Black 4, Black 5, Black 6, Black 7, Black 2 2×, Black 3 2×, Black 4 2×, Black 5 2×, Black 6 2×, Black 7 2×, 412, 419, 426, and 423; values on a Tri-stimulus Colorimeter of X=from about 0.05 to about 3.0; Y=from about 0.05 to about 3.0, and Z=from about 0.05 to about 3.0; in non glossy formulations; a CIE L a b of L=less than about 40, less than about 20, less than about 10, less than about 1, and about zero, of “a”=of any value; of “b”=of any value; and a CIE L a b of L=less than 50 and b=less than 1.0; an L value less than 30, a “b” value less than 0.5 (including negative values) and an “a” value less than 2 (including negative values); having a jetness value of about 200 M_{y} and greater, about 250 M_{y} and greater, 300 M_{y} and greater, and greater; having an L=40 or less and a My of greater than about 250; having an L=40 or less and a My of greater than about 300; having a dM value of 10; having a dM value of −15; and combinations and variations of these.

As used herein, unless stated otherwise, the term “gloss” is to be given its broadest possible meaning, and would include the appearance from specular reflection. Generally, the reflection at the specular angle is the greatest amount of light reflected for any specific angle. In general, glossy surfaces appear darker and more chromatic, while matte surfaces appear lighter and less chromatic.

As used herein, unless stated otherwise, the term “Jetness” is to be given its broadest possible meaning, and would include among other things, a Color independent blackness value as measured by M_{y} (which may also be called the “blackness value”), or M_{c}, the color dependent blackness value, and M_{y} and M_{c} values obtained from following DIN 55979 (the entire disclosure of which is incorporated herein by reference).

As used herein, unless stated otherwise, the term “undertone,” “hue” and similar such terms are to be given their broadest possible meaning, and would include among other things.

As used herein, unless stated otherwise, the terms “visual light,” “visual light source,” “visual spectrum” and similar such terms refers to light having a wavelength that is visible, e.g., perceptible, to the human eye, and includes light generally in the wave length of about 390 nm to about 770 nm.

As used herein, unless stated otherwise, the term “paint” is to be given its broadest possible meaning, and would include among other things, a liquid composition that after application as a thin layer to a substrate upon drying forms a thin film on that substrate, and includes all types of paints such as oil, acrylic, latex, enamels, varnish, water reducible, alkyds, epoxy, polyester-epoxy, acrylic-epoxy, polyamide-epoxy, urethane-modified alkyds, and acrylic-urethane.

As used herein, unless stated otherwise, the term “plastic” is to be given its broadest possible meaning, and would include among other things, synthetic or semi-synthetic organic polymeric materials that are capable of being molded or shaped, thermosetting, thermoforming, thermoplastic, orientable, biaxially orientable, polyolefins, polyamide, engineering plastics, textile adhesives coatings (TAC), plastic foams, styrenic alloys, acrylonitrile butadiene styrene (ABS), polyurethanes, polystyrenes, acrylics, polycarbonates (PC), epoxies, polyesters, nylon, polyethylene, high density polyethylene (HDPE), very low density polyethylene (VLDPE), low density polyethylene (LDPE), polypropylene (PP), polyvinyl chloride (PVC), polyethylene terephthalate (PET), polybutylene terephthalate (PBT), poly ether ethyl ketone (PEEK), polyether sulfone (PES), bis maleimide, and viscose (cellulose acetate).

As used herein, unless stated otherwise, the term “ink” is to be given its broadest possible meaning, and would include among other things, a colored liquid for marking or writing, toner (solid, powder, liquid, etc.) for printers and copiers, and colored solids that are used for marking materials, pigment ink, dye ink, tattoo ink, pastes, water-based, oil-based, rubber-based, and acrylic-based.

As used herein, unless stated otherwise, the term “adhesive” is to be given its broadest possible meaning, and would include among other things, substances (e.g., liquids, solids, plastics, etc.) that are applied to the surface of materials to hold them together, a substance that when applied to a surface of a material imparts tack or stickiness to that surface, and includes all types of adhesives, such as naturally occurring, synthetic, glues, cements, paste, mucilage, rigid, semi-rigid, flexible, epoxy, urethane, methacrylate, instant adhesives, super glue, permanent, removable, and expanding.

As used herein, unless stated otherwise, the term “coating” is to be given its broadest possible meaning, and would include among other things, the act of applying a thin layer to a substrate, any material that is applied as a layer, film, or thin covering (partial or total) to a surface of a substrate, and includes inks, paints, and adhesives, powder coatings, foam coatings, liquid coatings, and includes the thin layer that is formed on the substrate, e.g. a coating.

As used herein, unless stated otherwise, the term “sparkle” is to be given its broadest possible meaning, and would include among other things, multi angle reflections simultaneously imparted from the surface facets.

As used herein, the term “high temperature” means temperature in excess of 400° C., in excess of 500° C., in excess of 800° C., in excess of 900° C., from about 400° C. to about 1,200° C., from about 550° C. to about 850° C., and from about 600° C. to about 1,000° C. and all temperatures within these ranges.

Generally, the term “about” and the symbol “˜” as used herein unless stated otherwise is meant to encompass a variance or range of ±10%, the experimental or instrument error associated with obtaining the stated value, and preferably the larger of these.

As used herein, unless specified otherwise the terms %, weight % and mass % are used interchangeably and refer to the weight of a first component as a percentage of the weight of the total, e.g., formulation, mixture, preform, material, structure or product. The usage X/Y or XY indicates weight % of X and the weight % of Y in the formulation, unless expressly provided otherwise. The usage X/Y/Z or XYZ indicates the weight % of X, weight % of Y and weight % of Z in the formulation, unless expressly provided otherwise.

As used herein, unless specified otherwise “volume %” and “% volume” and similar such terms refer to the volume of a first component as a percentage of the volume of the total, e.g., formulation, mixture, preform, material, structure or product.

This Background of the Invention section is intended to introduce various aspects of the art, which may be associated with embodiments of the present inventions. Thus, the forgoing discussion in this section provides a framework for better understanding the present inventions, and is not to be viewed as an admission of prior art.

### SUMMARY

There has been a long-standing, increasing and unfulfilled need for, improved pigments and additives for plastics, paints, inks, coatings and adhesives, that can maintain their color, and in particular, maintain their blackness in high temperature applications and environments. The present inventions, among other things, solve these needs by providing the compositions of matter, materials, articles of manufacture, devices and processes taught herein.

There is provided a high temperature black ceramic pigment including: a ceramic matrix, the matrix consisting essentially of: silicon, oxygen, carbon and boron; wherein the ceramic pigment has a black color defining a degree of blackness; whereby when the pigment is exposed to a temperature of 1,000° F. for a period of 20 hours the degree of blackness does not change.

There is further provided these pigments having one or more of the following features: wherein the matrix is free from boric acid; wherein the matrix is free from boron oxide; and, wherein the matrix consists of silicon carbon oxygen and boron.

Yet additionally, there is provided a high temperature black ceramic pigment including: a ceramic matrix, the matrix including: silicon, oxygen, carbon and boron; and being free from boron oxide; wherein the ceramic pigment has a black color defining a degree of blackness; whereby when the pigment is exposed to a temperature of 1,000° F. for a period of 20 hours the degree of blackness does not change.

Moreover, there is provided a high temperature black ceramic pigment including: a ceramic matrix, the matrix including: silicon, oxygen, carbon and boron; and being free from boric acid; wherein the ceramic pigment has a black color defining a degree of blackness; whereby when the pigment is exposed to a temperature of 1,000° F. for a period of 20 hours the degree of blackness does not change.

There is further provided these pigments having one or more of the following features: wherein the matrix is free from boron oxide; wherein the matrix defines and inner section of the pigment, having an outer surface; and a coating on the outer surface on the inner section of the pigment; the coating including boric acid, boron oxide or both; wherein the matrix defines and inner section of the pigment, having an outer surface; and a coating on the outer surface on the inner section of the pigment; the coating including boron; wherein the matrix has boron-spices selected from the group consisting of: BC, BC₂, and BC₃; wherein the matrix has boron-spices selected from the group consisting of: B(OSi)₃, B (OSi)₂OB, B(OSi) OB₂, and BOSiBC₃; wherein the matrix has boron-spices selected from the group consisting of: BOC₂, BCSi, BO₂C, BOCSi, and BCSi₂; and wherein the ceramic matrix has about 4-11.5% of incorporated Boron as an atomic percentage, about 36-55% of O as an atomic percentage, about 12.7-22.5% Si as an atomic percentage, and about 17-41% of C as an atomic percentage; wherein the silicon, oxygen and carbon having from about 15.3 mole % to about 63.1 mole % silicon, from about 8.8 mole % to about 56.8 mole % oxygen, and at least about 6.3 mole % carbon, and wherein about 20 weight % to about 80 weight % of the carbon is silicon-bound-carbon and about 80 weight % to about 20 weight % of the carbon is free carbon.

Yet additionally there is provided a black polysilocarb derived ceramic pigment including boron, silicon, oxygen and carbon, and free from boric acid.

There is further provided these pigments having one or more of the following features: wherein the degree of blackness is selected from the group consisting of: PMS 433, Black 3, Black 3, Black 4, Black 5, Black 6, Black 7, Black 2 2×, Black 3 2×, Black 4 2×, Black 5 2×, Black 6 2×, and Black 7 2×; wherein the degree of blackness is selected from the group consisting of: Tri-stimulus Colorimeter of X from about 0.05 to about 3.0, Y from about 0.05 to about 3.0, and Z from about 0.05 to about 3.0; a CIE L a b of L of less than about 40; a CIE L a b of L of less about 20; a CIE L a b of L of less than 50, b of less than 1.0 and a of less than 2; and a jetness value of at least about 200 M_{y}; wherein when the pigment is exposed to a temperature of 1,000° F. for a period of 40 hours the degree of blackness does not change; wherein when the pigment is exposed to a temperature of 1,000° F. for a period of 500 hours the degree of blackness does not change; wherein when the pigment is exposed to a temperature of 1,200° F. for a period of 20 hours the degree of blackness does not change; wherein when the pigment is exposed to a temperature of 1,200° F. for a period of 40 hours the degree of blackness does not change; and, wherein when the pigment is exposed to a temperature of 1,200° F. for a period of 500 hours the degree of blackness does not change.

Still further, there is provide a coating formulation including: a first material and a second material; wherein the first material defines a first material weight percent of the coating formulation and the second material defines a second material weight percent of the coating formulation; wherein the second material is a black polymer derived ceramic material including boron and silicon, oxygen and carbon, wherein the silicon oxygen and carbon having from about 30 weight % to about 60 weight % silicon, from about 5 weight % to about 40 weight % oxygen, and carbon; wherein about 20 weight % to about 80 weight % of the carbon is free carbon; and wherein the first material weight percent is larger than the second material weight percent.

Furthermore, there is provided these coating formulations of having one or more of these high temperature boron containing black pigments, wherein the first material has a system selected from the group of systems consisting of acrylics, lacquers, alkyds, latex, polyurethane, phenolics, epoxies and waterborne.

Additionally, there is further provided these coating formulations of having one or more of these high temperature boron containing black pigments, wherein the first material has a material selected from the group consisting of HDPE, LDPE, PP, Acrylic, Epoxy, Linseed Oil, PU, PUR, EPDM, SBR, PVC, water based acrylic emulsions, ABS, SAN, SEBS, SBS, PVDF, PVDC, PMMA, PES, PET, NBR, PTFE, siloxanes, polyisoprene and natural rubbers.

In addition, there is further provided these coating formulations of having one or more of these high temperature boron containing black pigments, wherein the coating formulation is a paint formulation selected from the group consisting of oil, acrylic, latex, enamel, varnish, water reducible, alkyd, epoxy, polyester-epoxy, acrylic-epoxy, polyamide-epoxy, urethane-modified alkyd, and acrylic-urethane.

Yet further, there is further provided these coating formulations of having one or more of these high temperature boron containing black pigments, wherein the coating is selected from the group consisting of industrial coatings, residential coatings, furnace coatings, engine component coatings, pipe coatings, and oil field coatings.

Moreover, there is provided a coating formulation including: a carrier material and a black polymer derived ceramic pigment including boron and silicon, carbon and oxygen, wherein the silicon carbon and oxygen having from about 30 weight % to about 60 weight % silicon, from about 5 weight % to about 40 weight % oxygen, and at least 5 weight % carbon, and wherein about 20 weight % to about 80 weight % of the carbon is silicon-bound-carbon.

Still additionally, there is provided a black polysilocarb derived ceramic pigment including boron, silicon, oxygen and carbon, wherein the silicon, oxygen and carbon having from about 15.3 mole % to about 63.1 mole % silicon, from about 8.8 mole % to about 56.8 mole % oxygen, and at least about 6.3 mole % carbon, and wherein about 20 weight % to about 80 weight % of the carbon is silicon-bound-carbon and about 80 weight % to about 20 weight % of the carbon is free carbon; and wherein the boron is a coating layer on the SiOC substrate.

### BRIEF DESCRIPTION OF THE DRAWINGS

FIG. 1 is a schematic flow diagram of an embodiment of a system in accordance with the present inventions.

### DESCRIPTION OF THE PREFERRED EMBODIMENTS

In general, the present inventions relate to ceramic materials for use as, or in, colorants, inks, pigments, dyes, additives and formulations utilizing these materials. Embodiments of the present inventions, among other things, relate to ceramic materials having blackness, black color, and which are black; starting compositions for these ceramic materials, and methods of making these ceramic materials; and formulations, compositions, materials that utilize or have these ceramic materials. Various embodiments of the present inventions, in particular, relate to, or utilize, such ceramic black materials that are boron containing polymer derived ceramics. Embodiments of the present inventions also relate to black ceramics having boron, silicon, oxygen and carbon, and methods of making these ceramics; formulations utilizing these black ceramics; and devices, structures and apparatus that have or utilize these formulations. Embodiments of the present invention in general include plastics, paints, inks, coatings, formulations, liquids and adhesives containing boron based ceramic black materials, including boron polymer derived black ceramic materials, and preferably boron polysilocarb polymer derived ceramic materials.

Embodiments of the present inventions include polymer derived ceramics (PDCs) that contain boron, e.g., include boron, incorporate boron, or contain boron moieties and boron compositions. These embodiments preferably are polysilocarb precursors, formulations, cured materials, plastics, preceramic, and ceramics that contain boron, e.g., include boron, incorporate boron, or contain boron moieties and boron compositions. Embodiments of the present inventions include methods of making these boron containing PDCs and products and materials incorporating or utilizing these boron containing PDCs.

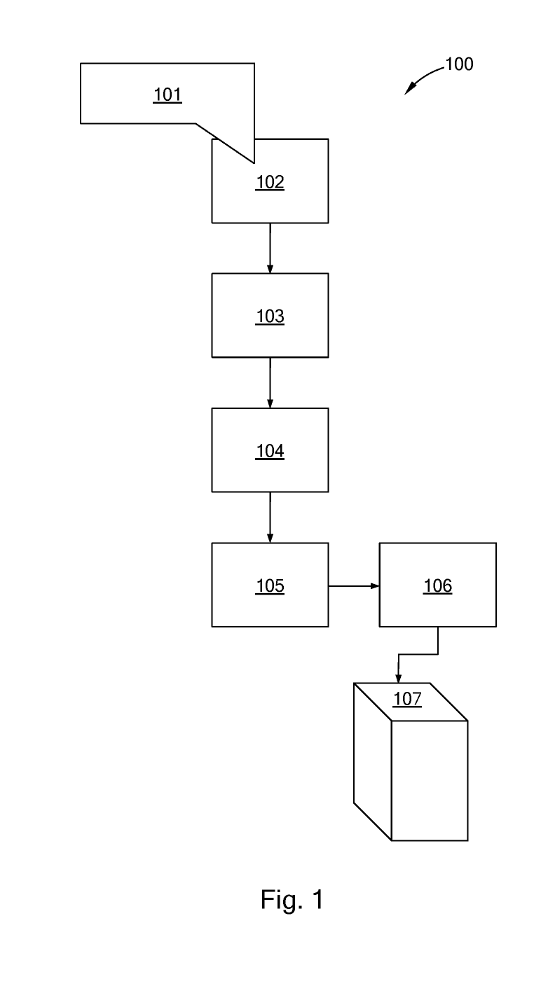

Turning to FIG. 1 there is provided a process flow chart 100 for an embodiment having several embodiments of the present processes and systems. Thus, there is a precursor make-up segment 101, where the boron containing PDC precursor formulations are prepared. There is a forming segment 102 where the boron containing PDC precursor is formed into a shape, e.g., bead, slab, particle, etc. There is a curing segment 103, where the boron containing PDC precursor is cured to a cured material, which is substantially solid, and preferably a solid. There is a pyrolysis segment 104, where the cured material is converted to a ceramic, e.g., a PDC, which preferably is a boron containing SiOC ceramic. There is a post-processing segment 105, where the ceramic is further processed, e.g., washing, grinding, agglomeration, milling, cycloning, sieving, etc. There is a formulation segment 106, where the boron containing PDC is processed into a material formulation (e.g., paint, plastic, ink, coating and adhesive), containing the boron containing PDC, i.e., a boron-PDC containing material formulation. Boron-PDC containing material formulations include, among other things, boron-PDC paints, boron-PDC plastics, boron-PDC inks, boron-PDC adhesives, and boron-PDC coatings. There is an application segment 107, where a boron-PDC containing material formulation is applied to a substrate, e.g., a refrigerator, vehicle, appliance or other items, and components of such items.

The precursor make-up segment can be any of the systems, processes and materials disclosed and taught, and incorporated by reference in this specification. The forming segment can be any of the systems, processes and materials disclosed and taught, and incorporated by reference, in this specification. Embodiments of the curing segment can be any of the systems, processes and materials disclosed and taught, and incorporated by reference, in this specification. The pyrolizing segment can be any of the systems, processes and materials disclosed and taught, and incorporated by reference in this specification.

The post-processing segment can involve any type of further processing activities to enhance, effect, or modify the performance, handleability, processability, features, size, surface properties, and combinations and variations of these. Thus, for example, the post-processing step can involve a grinding step in which the PDC is reduced in size to diameters of less than about 10 μm, less than about 5 μm, less than about 1 μm, less than about 0.5 μm, and less than about 0.1 μm, from about 10 μm to about 0.1 μm, from about 2 μm to about 0.5 μm, about 3 μm to about 0.05 μm, and from about 1 μm to about 0.1 μm, and all sizes within these ranges, as well as larger and smaller sizes. The PDC can be ground, for example, by the use of a ball mill, an attrition mill, a rotor stator mill, a hammer mill, a jet-mill, a roller mill, a bead mill, a media mill, a grinder, a homogenizer, a two-plate mill, a dough mixer, and other types of grinding, milling and processing apparatus. The post-processing segment can involve, for example, an agglomeration, where smaller PDC particles are combined to form larger particles, preferably agglomerated particles having diameters of at least about 2 μm, about 2.5 μm, greater than 2.5 μm, about 3 μm, about 5 μm, about 10 μm, greater than 10 μm, and greater than 12 μm, from about 1 μm to about 15 μm, from about 2 μm to about 10 μm, about 2.5 μm to about 7.5 μm, and about 3 μm to about 12 μm, and all sizes within these ranges, as well as larger and smaller sizes. Preferably, the agglomerated particles are sufficiently bound, or held together, to prevent the particles from falling off, e.g., separating from, the agglomeration during handling, shipping, storage, and processing, e.g., “handling strength.” More preferably, the strength of the agglomerations is only slightly greater than the handling strength, and in this manner can readily be broken apart into the smaller particles for use in a PDC material formulation. For example, the agglomeration can have a strength, e.g., crush strength, that is less than about 1/2000 of the strength of the smaller particles, e.g., primary particles, that form the agglomeration, less than about 1/500 of the strength of the smaller particles, less than about 1/75 of the strength of the smaller particles, less than ½ of the strength of the smaller particles, from about ½ of the strength of the smaller particles to about 1/2000 of the strength of the smaller particles, from about 1/10 of the strength of the smaller particles to about 1/1000 of the strength of the smaller particles, from about 1/20 of the strength of the smaller particles to about 1/500 of the strength of the smaller particles, and from about 1/10 of the strength of the smaller particles to about 1/100 of the strength of the smaller particles, and all values within these ranges, as well as larger and smaller values.

The agglomeration can, for example, be formed by using spray drying techniques. Suitable binders, including for example sizing agents, for use in spray drying techniques include for example: dispersants, surfactants, soaps, copolymers, starches, natural and synthetic polymers and saccharides, lipids, fatty acids, petroleum-derived polymers and oligomers. Sodium alginate, corn starch, potato starch, and other naturally derived starches, fructoses, sucroses, dextroses and other naturally or synthetically derived saccharides and sugars, polylactic acid and other naturally derived polymers, cellulosic byproducts, carrageenan and other natural products, poly vinyl acetate and other water-soluble polymers, wetting and dispersing agents such as polyacrylates, polyethylene oxides, polypropylene oxides, and copolymers containing them. Parrafins and other waxes, other petrochemical derivatives and petroleum based polymers. Surfactants such as Tween, Span, Brij, and other types of surfactants; Stearates, oleates, and other modified oils; linear copolymers, branched copolymers, star polymers and copolymers, hyperbranched polymers and copolymers, comb-like polymers, and combinations and variations of these.

The amount of binder used to PDC to form an agglomerate can range from about 0.01% to 5%, about 0.1% to about 2%, about 0.25% to about 1%, about 0.1% to about 5%, and preferably less than about 1% and less than about 0.5%, and all values within these ranges, as well as larger and smaller values. Agglomerates can also be formed by batch evaporation and casting, thin film evaporation, wiped-film evaporation, tray drying, oven drying, freeze drying, and other suitable evaporation methods, aggregation techniques such as sedimentation, solvent exchange and coagulation, pin mixing, filtration, and others, preferably combined with a drying technique, and combinations and variations of these. Further, processing may involve the application of a surface treatment, wash, or coating to the surface of the PDC particles to provide predetermined features to the PDCs, such as for example, enhanced antistatic, wettability, material formulation compatibility, mixability, etc.

It should be noted that while surface treatments are contemplated by the present inventions to further enhance, e.g., specialize the PDC particles for a particular purpose; an advantage of the present inventions is the feature that they are more readily mixed, added, or compiled into material formations, e.g., paints, plastics, inks, coating and adhesives, than the prior art black pigments, e.g., carbon black ((ASTM Color Index) CI Black 1,6,7) or graphite (CI Black 10) or metal oxides and mixed metal oxides, including but not limited to iron oxides (CI Black 11) and Manganese Iron oxide (CI Black 26) or Iron Manganese oxide (CI Black 33), Manganese oxide (CI Black 14), Copper oxide (CI Black 13), Copper Manganese Iron oxide (CI Black 26) or Copper Chrome oxide (CI Black 28), and pigment made by ashing organic matter (CI Black 8, 9), which typically for many applications require surface treatments. Thus, an advantage of the present inventions, among other things, is the ability to use untreated boron-PDC particles, e.g., no surface treatments, in materials formulation.

In the formulation segment, the making of the boron-PDC material formulation (e.g., paint, plastic, ink, coating and adhesive) takes place. Thus, for example, the boron-PDC ceramic is mixed into, added to, or otherwise combined with the materials used to make up the material formulation. Generally, an agglomerate easily breaks down into its primary particles, e.g., the primary party state; and the primary particles are uniformly and smoothly distributed or suspended in the primary formulation material, which can be obtained in less than 60 minutes of mixing, less than 30 minutes of mixing and quicker. Typically, the boron-PDC ceramic is much more easily mixed into the material formulation than carbon black to a fully dispersed state. For example, and by way of illustration, boron-PDC ceramic can be easily and quickly mixed within 10 minutes into a vessel in which a simple 3 blade stirrer is mixing at 1,000 rpm tip speed. The resin, boron-PDC ceramic mixture will be fully dispersed which is illustrated by a reading of greater than 7 on the Hegman gauge. The Hegman gauge is a calibrated device to quickly show how fine a dispersion is made. A carbon black or oxide black pigment mixed into the resin in the same manner would produce a Hegman reading of less than 1 which indicates very large particles still in the resin, because these pigments require high energy milling to break up the aggregates in the ‘as supplied’ pigment. Generally, the boron-PDC ceramic can be mixed into, added to, or otherwise combined with the material formulation in the same manner, using the same or existing equipment, that are present for use with other black pigments or colorants. Preferably, for many applications less expensive, quicker, more efficient equipment and much less expensive processes, than are needed for carbon black or oxide black pigment, can be used with the PDC particles.

In the application segment the boron-PDC containing material formulation is applied to an end product, or a component that may be used in an end product. The boron-PDC containing material formulation can typically, and preferably, be applied using the same types of techniques that are used for carbon black based material formulations, e.g., brush, spray, dip, etc. Moreover, the boron-PDC containing material formulations have applications, and the ability to be applied, in manners that could not be accomplished with a similar carbon black based formulation.

The boron-PDC material formulations can survive much higher temperatures than carbon black based formulations. Thus, the boron-PDC material formulations can survive and be stable at temperatures that are about 100° C. greater, that are about 200° C. greater, that are about 500° C. greater, that are about 700° C. greater, and that are from about 100° C. to about 800° C. greater, and all values within these ranges, as well as larger and smaller values, than comparable or the same material formulation utilizing carbon black.

It should be understood that the various segments of the embodiment of FIG. 1 can be combined (e.g., a single piece of equipment could perform one of more of the operations of different segments, such as curing and pyrolizing), conducted serially, conducted in parallel, conducted multiple times, omitted (e.g., post-processing many not be necessary or required), conducted in a step wise or batch process (included where the segments are at different locations, separated by time, e.g., a few hours, a few days, months or longer, and both), conducted continuously, and in different orders, conducted at different locations, conducted at different times, and combinations and variations of these. Thus, for example the post-processing segment of grinding can be performed on the cured material prior to pyrolysis, and can also be performed on both the cured and pyrolized materials.

In general, in an embodiment, the boron-PDC can have boron carbon spices incorporated into the back bone of the PDC precursor, and upon cure and pyrolysis, will have boron carbon spices incorporated into the plastic and ceramic matrix. In this embodiment, where the boron is incorporated into the back bone of the precursor, the plastic and the ceramic materials have little to no boric acid (e.g., less than 1%, less than 0.5%, less than 0.01%, less than 0.001%, less than 0.0001%, and less than 0.00001%) and little to no boron oxide (e.g., less than 1% and less than 0.5%, less than 0.01%, less than 0.001%, less than 0.0001%, and less than 0.00001%) and preferably are free from boric acid, boron oxide, and both.

By “free from” it is meant that that none of the specified material or substance is present. Thus, for example, a Boron-PDC ceramic pigment that is free from boric acid means that there is no boric acid present in that material.

In an embodiment, the boron-PDC ceramic is free from boron nitrides, free from other boron-nitrogen materials, and both.

In another embodiment, Boric acid, boron oxide, and both can be added to the plastic or ceramic as a coating or other post treatment. While both embodiments show high temperature resistance properties, it is theorized, as discussed in greater detail in this specification, that their mechanisms of operation to provide high temperature resistance, e.g., stability, including color fastness, and retentions of blackness, at high temperatures, are very different.

The boron carbon back bone embodiment, can further be post treated with boric acid, boron oxide and both. In this manner, the two embodiments can be combined into another embodiment. Thus, there can be a black pigment, that has a ceramic structure, e.g., internal structure, that is boron oxide and boric acid free, and that has a coating, e.g., outer coating on, or surround, the internal ceramic structure, that contains boron oxide, boric acid or both.

Typically, in the boron carbon back bone embodiment the boron is part of the ceramic structure, and preferably the backbone of the ceramic structure, through covenant bonds. For the boron carbon back bone embodiment, in general, an embodiment of a method to make this material has a precursor material that is a silane having oxy-functionality that is bonded with a precursor having a high (large) source of carbon, in the presence of an initiator. The product of this first reaction is reacted with borate (which can be formed by a second reaction between boric acid (B(OH)₃ and methanol). The first and the second reactions can be performed together in the same vessel or in separate steps. This third reaction product is a liquid which can them be cured into a plastic and pyrolized into a ceramic.

Reaction 1, between the high carbon containing precursor R₅ and the oxy-functionalized saline is set forth below.

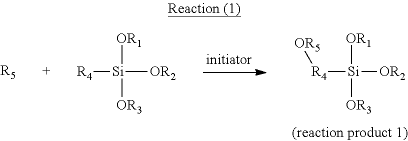

The silane having oxy-functionality is generally a silicon atom (or atoms) having one, two or three alkoxide groups (—O—R, where, R_{1, 2, or 3} can be an alkyl group, an alkene group, and a cyclic structure). In additional other groups may be used to provide the oxy-functionality, such as alkyl groups silanes with 1-4 such functional groups. Thus, in the above reaction there can be one alkyl group or two or three or four alkyl groups, and preferably methoxy groups as shown in R₄, OR₁, OR₂ and OR₃. Preferably, the oxy-functionality groups are methoxy (—O—CH₃) or ethoxy groups (—O—CH₂—CH₃). In addition to having one, two or three alkoxide groups, each of those groups present can be the same or different. Thus, R₁, R₂, R₃ can be any of these alkoxide or other groups to provide oxy-functionality, and R₁, R₂, R₃, can be the same or different.

The silane oxy-functional starting material, also has one, two or three other functional groups R₄ for bonding the silicon atom to the high carbon content precursor. These bonding groups are preferably a vinyl (—C═C) group, an allyl group (—C—C═C), other alkene groups, as well as, others such as epoxide groups.

The high carbon precursor R₅ can be any of the silicon based polymer derived ceramic precursors having 5 or more carbon atoms, and non-silicon organic crosslinking agents, such as: cyclopentadiene (CP), methylcyclopentadiene (MeCP), dicyclopentadiene (DCPD), methyldicyclopentadiene (MeDCPD), tricyclopentadiene (TCPD), piperylene, divnylbenzene, isoprene, norbornadiene, vinylnorbornene, propenylnorbornene, isopropenylnorbornene, methylvinylnorbornene, bicyclononadiene, methylbicyclononadiene, propadiene, 4-vinylcyclohexene, 1,3-heptadiene, cycloheptadiene, 1,3-butadiene, cyclooctadiene and isomers thereof. Generally, any hydrocarbon that contains two (or more) unsaturated, C═C, bonds that can react with a Si—H, Si—OH, or other Si bond in a precursor, can be used as a cross-linking agent. Some organic materials containing oxygen, nitrogen, and sulphur may also function as cross-linking agents.

In a preferred embodiment R₁, R₂, and R₃ are methoxy groups, R₄ is a vinyl group, and R₅ is DCPD.

Typically reaction 1 can be conducted from about 40-70° C., and generally the reaction can be conducted at 40-130° C., although higher and lower temperatures could be employed. The reaction can be conducted at atmospheric pressure and under nitrogen or air. Other conditions may also be used.

The initiator can be Azo compounds (R—N═N—R′) or peroxide compounds. For example, AIBN (Azobisisobutyronitrile) or AICN (Azobis cyanocyclohexane).

The Borate that are then reacted with the product of reaction 1 can be formed by reaction 2 set forth below.

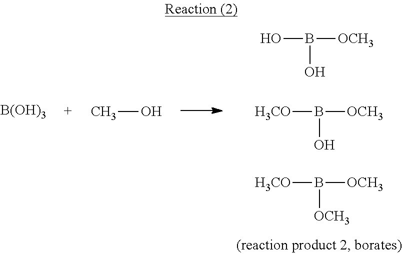

Generally, the amount of R₅ to the coupling group R₄ in the reaction can be from about 1:1 to 1:5. The amount of boric acid to methanol can be from about 1:1 to 1:20.

The borates are then reacted with the reaction product of reaction 1 to form a poly borosiloxane, for example, as set forth below.

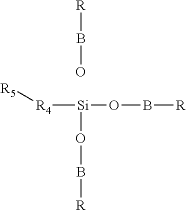

The poly borosiloxane is then cured to form a plastic having the general structure show below.

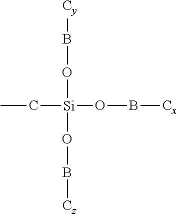

The cured poly borosiloxane plastic is then pyrolized to form a SiOBC ceramic having boron carbon species (e.g., moieties having boron carbon bonding) in the structure. These boron carbon species can be as part of the ceramic matrix (covalent bonds of the ceramic matrix), bound or within the ceramic matrix, and combinations of these.

The boron-carbon species in the ceramic matrix would be BC, BC₂ and BC₃, and the other born species in the ceramic matrix would include B(OSi)₃, B (OSi)₂OB, B(OSi) OB₂, BOSiBC₃, BOC₂, BCSi, BO₂C, BOCSi, and BCSi₂. The ceramic matrix can have about 4-11.5% of incorporated Boron (atomic percentage), about 36-55% of O (atomic percentage), about 12.7-22.5% Si, about 17-41% of C. The ceramic matrix, in an embodiment can be free from all other materials. Moreover, in a preferred embodiment there is no boric acid or boron oxide (B₂O₃, B₂O and B₆O) present.

In embodiments, these boron species are generally evenly, and preferably uniformly distributed throughout the ceramic matrix and thus throughout the structure of the pigment particle. In the case of a coated particle, these boron species are generally evenly, and preferably uniformly distributed throughout the internal structure of embodiments of the coated particle.

It being understood that these boron-SiOC backbone incorporated ceramic materials can be made by other reactions and pathways, in addition to reaction 1 and reaction 2.

Other processes, methods and synthesis routes can be used to make the boron carbon backbone embodiments of the present inventions. It is believed that new synthesis routes that can simplify the process, reduce costs, and both, can be designed, developed and implemented. If is believed that one or more, and combinations and variations, of the following synthesis route, set out in Table 4, can be used to provide the boron carbon backbone embodiments.

TABLE 4

| | |
|---|---|
| Silanol terminated polydiphenyl siloxane | 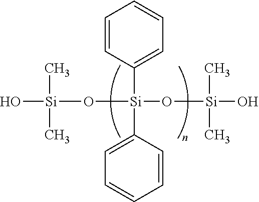 |
| Silanol terminated vinyl- methysiloxane dimethysiloane copolymer | 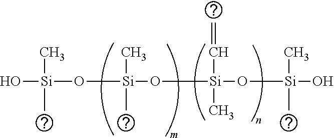 |
| Silanol terminated PDMS | 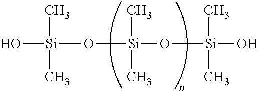 |
| Silanol terminated copolymer of polydiphenyl siloxane and PDMS | 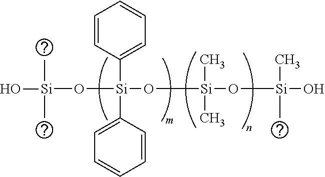 |
| Diphenyl- | SiSiB ® PC6228 |
| dihydroxysilane | Diphenyldihydroxysilane |
| | Synonym: Dihydroxydiphenylsilane; |
| | Diphenylsilanediol |
| | Chemical Structure |
| | 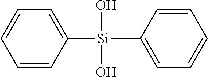 [SMILES: O[Si](O)(c1ccccc1)c1ccccc1] |

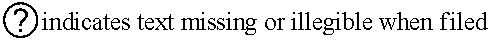

In an embodiment of a process, the raw materials include: boric acid, silanol terminated polysiloxane and methanol as solvent. May also include dicyclopentadiene and AIBN (or other types of free radical initiators such as peroxide). The synthesis involves dissolving boric acid in methanol at elevated temperature such as 50-70 C and mixing with one of the above silanol terminated polysiloxane, and react at such temperature or higher for several hours while removing methanol either by vacuum or evaporation. Curing will be done at 120° C. for 6 hr or longer followed by pyrolysis at 1150° C.

It is theorized that in the embodiment of the boron-PDC where the boron is incorporated into the backbone of the ceramic, high temperature resistance, survivability, is provided through a unique mechanism. As carbon and oxygen are removed from the surface under high temperature conditions, more and more boron is exposed to, becomes the surface of the material. The increasing concentration of boron on the surface that occurs with increasing temperature, increasing time at elevated temperatures and both, thus provides the high temperature resistance and stability of the boron-PDC material.

In the other embodiment where boric acid and boron oxide are coated onto the ceramic material, instead of being incorporated into the backbone of the ceramic matrix. The boron oxide and boric acid have lower melting temperatures than the PDC, and in particular the SiOC PDC materials. As the temperature increase the boron melts and covers the surface of the PDC material protecting it from the higher temperatures.

In a preferred embodiment the boron-PDC material is a boron-SiOC ceramic, and more preferably is a boron-SiOC ceramic having the boron incorporated into the backbone of the ceramic matric. These boron-SiOC materials, (e.g., boron coated SiOC ceramic and boron backbone incorporated SiOC ceramics) can be used as high temperature pigments, fillers and additives, among other things. They provide excellent high temperature resistance to the materials they are incorporated into, or materials that contain them.

Embodiments of coatings, including the high temperature boron-SiOC pigments, are oxidation resistant, and for the high temperature coating embodiments, will have lower or less oxidation than non-SiOC pigment containing coatings, and non-boron-SiOC pigment containing coatings, and preferably will not noticeably (e.g., as preserved by the eye, through a greying color change) oxidize at these temperatures, thickness and times set forth in this specification. In a preferred embodiment a boron-SiOC pigment containing coating resists color deterioration to a delta E of less than 1.5 after 1,000 hours of exposure at 1200° F. (650° C.). In an embodiment the boron-SiOC pigment containing film is exposed for only 20 hours of high temperature 1200° F. (650° C.) using the testing procedures of ASTM D4587, the entire disclosure of which is incorporated herein by reference.

It is believed that high temperature stability, in embodiments of the present boron-SiOC pigments, have a correlation to the ratio of Si to B, and that in a preferred embodiment the ratio is about 1:1. In an embodiment of the present process the boron-PDC pigment is pyrolized at temperature from about 1100° C. to 1200° C. In an embodiment the amount of DCPD as a precursor can vary from 0% to 50%.

Embodiments of coatings that contain the boron-SiOC pigment, and preferably boron-backbone incorporated SiOC pigment, can meet, one, two, or more, and all of the following ASTM features, or performance criteria.

Corrosion Resistance

ASTM B117, salt fog corrosion testing—need to pass 1,000 hours to 5000 hours of continuous exposure to a Nuetral Salt Spray at 40° C. by having no defect in the coating outside of the scribe.

Embodiments of the present coatings, preferably also meet more aggressive cyclic corrosion testing which is conducted by to demonstrate corrosion resistance more closely aligned with actual end use conditions.

Heat Resistance

ASTM D2485, heat resistance test up to 1,200° F.—need to have a DE of less than 1.5 color difference, no cracking when coating is heated and exposed to placing it into a bucket of room temperature water, no micro-cracking in the coating as seen under microscope to 75×.

Humidity Resistance

ASTM D4585, pass 1,000 to 5,000 hours without any film deformation.

Chemical Resistance

ASTM D1308, must not have permanent deformation when exposed to household chemicals, solvents, acids or bases.

Adhesion

Cross hatch ASTM D3359, must not have any film removed with tape pull, 4b. Pull tab ASTM D4541, must not have any film removed.

Impact Resistance

ASTM D2794, 80/20 inch pounds.

Hardness

Pencil hardness ASTM D3363, 9 h to 6 h.

ASTM D3363, Scratch resistance, F.

Mandrel Bend

ASTM D522, no coating loss at 45′ rotation

Pot Life

ASTM D1200, 3 hours

The entire disclosure of the forgoing ASTM standards is incorporated herein by reference.

An embodiment of a boron-SiOC ceramic pigment is a colorant suitable and advantageous in multiple fields such as industrial, architectural, marine and automotive systems. The boron-SiOC ceramic pigment can preferably easily disperses into acrylics, lacquers, alkyds, latex, Polyurethane, phenolics, epoxies and waterborne systems providing a durable, uniform coating and pleasant aesthetics in all types of finishes, e.g., matte and gloss.

The boron-SiOC ceramic pigment can preferably be low dusting. The boron-SiOC ceramic pigment does not typically accumulate charge, it is easy to clean up, and does not cling to surfaces. The boron-SiOC ceramic pigment is considerably easier to clean up, and control dusting than typical carbon black. It is theorized that the typical carbon black's strong hydrophobicity, light particle weight, and very small particle size (e.g., 50 nm to 200 nm), among other things, makes carbon black much more difficult to clean up and control than the boron-SiOC ceramic pigment. As such, it is preferably a non-sticking, non-clinging black pigment. These, among other features, are a significant improvement over carbon black, which is typically difficult to clean up, dusts, and clings to surfaces.

The boron-SiOC ceramic pigment can have low oil absorption, leading to lower viscosities, which among other things, permits formulations to move to higher solids loading with lower VOC content. This pigment can have a diameter, for example, from about 0.1 μm to 300 μm, from about 1 μm to about 150 μm, less than 10 μm, less than 1 μm, less than 0.3 μm, and less than or equal to 0.1 μm.

An embodiment of a batch of the boron-SiOC pigment, can have narrow or tight particle size (e.g., diameter) distribution. Thus, embodiments of these black ceramic pigments are particles that are within at least 90% of the targeted size, at least 95% of the targeted size, and at least 99% of the targeted size. For example, the patch of particles, can have size distributions such as at least about 90% of their size within a 10 μm range, at least about 95% of their size within a 10 μm range, at least about 98% of their size within a 10 μm range, and at least about 99% of their size within a 10 μm range. Further, and for example, the process can produce particles each of which can have at least about 90% of their size within a 5 μm range, at least about 95% of their size within a 5 μm range, at least about 98% of their size within a 5 μm range, and at least about 99% of their size within a 5 μm range. Further, and in submicron particle sized, for example, the process can produce particles each of which can have at least about 90% of their size within a 0.2 μm range, at least about 95% of their size within a 0.2 μm range, at least about 98% of their size within a 0.2 μm range, and at least about 99% of their size within a 0.2 μm range. More preferably, in sub micron sizes, embodiments these percentage tolerances can be for the 0.1 μm range, and the 0.05 μm range. Preferably, these levels of uniformity in the production of the particles are obtained without the need for filtering, sorting or screening the particles.

It should further be noted that preferably these size distributions are for particles, as used in the formulation. Thus, these particle size distributions can be agglomerated, and then upon de-agglomeration and preferably will have the same, substantially the same particle size distribution. In this manner, preferably the particle size, and size distribution after de-agglomeration are predictable and predetermined.

In a preferred embodiment the boron-SiOC pigments is a black non-conductive, acid and alkali resistant, and thermally stable up to about 300° C., up to about 400° C. and up to about 500° C., or greater, and at high temperatures, e.g., stable at from about 300° C. to about 500° C., and from about 300° C. to about 600° C. In other embodiments the conductive properties of the pigment can be modified with additives and fillers, during the making of the pigment, and in this way providing a pigment that is conductive, and has a predetermined conductivity. The color and jetness of these black boron-SiOC pigments is typically a function of the particle size. In a preferred embodiment of the boron-SiOC pigment, mass-tone and tint strength can be comparable to, and in a further preferred embodiment can be superior to, current black pigments, e.g., carbon, carbonaceous, and oxide based black pigments. In preferred embodiments the boron-SiOC pigments are non-hazardous, having no toxicological effects.

Embodiments of the black boron-SiOC pigments can be used in, among other things, spray, brush-on and power coatings for applications on essentially all metal, ceramic and plastic surfaces in the industrial, marine, architectural, graphic arts & inks, and automotive fields. Embodiments of these pigments further can find applications in cosmetics, nail polish, food packaging, and pharmaceutical applications and fields, to name a few.

Embodiments of the black boron-SiOC ceramic pigments are easily dispersed in most media. The black boron-SiOC pigments are easily and readily dispersed in most types of media, basis, resins and carriers. For example, HDPE, LDPE, PP, Acrylic, Epoxy, Linseed Oil, PU, PUR, EPDM, SBR, PVC, water based acrylic emulsions, ABS, SAN, SEBS, SBS, PVDF, PVDC, PMMA, PES, PET, NBR, PTFE, siloxanes, polyisoprene and natural rubbers, and combinations of these and others.

Embodiments of the black boron-SiOC ceramic pigments have very low oil absorption. The oil absorption for boron-SiOC ceramic pigments can be less than about 50 (grams linseed oil per 100 grams of pigment, i.e. g/100 g), less than about 30 g/100 g, and less than about 15 g/100 g. On the other hand, typical specialty carbon black pigments have oil absorptions ranging from about 150 g/100 g to more than 200 g/100 g. Thus, embodiments of the present black boron-SiOC ceramic pigments can have oil absorptions that are at least 13×, 5× or 3× lower than carbon black pigments having the same or similar blackness.

Embodiments of the black boron-SiOC ceramic pigments can find use in many applications and industries. For example, the boron-SiOC derived ceramic pigments provide high temperature resistance capabilities, they are indoor/outdoor color fast, UV resistant, and are resistant to most chemicals, finding applications in harsh environments, such as marine and oil field environments. They are non-corrosive and non-conductive, which enables uses beyond that which most black pigments could be utilized. These uses would include Industrial and residential furnace coatings; engine components as high heat resistant plastic parts or coatings on metal parts; pipe coatings; chemical plant equipment coatings; oil field coatings; residential barbeques; aftermarket coatings; ceramic and glass inkjet inks; electronic coatings; battery anodes; gun barrel coatings; PVC siding, metal roof coatings; coloration of ceramic parts for many end uses; space craft coatings; sand coatings; microwave curable elastomers, plastics, inks and coatings; cookware; hotplates; satellite components; high heat absorbing coatings; proprietary military coatings; high heat resistant potting compound; electrical insulation; Fluoropolymer elastomers for use as seals and gaskets in extremely harsh environments; high emissivity coatings, thermal protection systems, thermal barrier coatings, thermal imaging coatings, injection-molded parts, thermoformed parts, transfer molded parts, compression molded parts, rotational molded parts, blow-molded parts, cast parts, vacuum formed parts, hot-isostatic pressed parts, sinterable parts, vacuum impregnated parts, impregnated fiber forms, woven fabrics, textiles, engineering textiles, woven fiber fabrics, fiber mats, wear resistant metal matrix composites, wear resistant ceramic matrix composites, wear resistant polymer matrix composites, mixed oxide ceramics, refractory applications, and combinations and variations of these and others.

Embodiments of the black boron-SiOC ceramic pigments are microwave safe, e.g., they do not absorb and are not effect by microwaves. Typical carbon black pigments, are effected by microwaves, and cannot be used in microwave environments or applications.

Boron-SiOC ceramic pigments have applications in, for example, coatings used on, or in, walls, appliances, automobiles, engines, pipes, grills, microwaves, cook wear, wires, printed circuit boards, human and animal nails, cosmetics, pipes, interior of components such as automobile components, food packaging and other devices, structures components and articles. They have applications in coatings that provide end use features, such as for example, corrosion protection, abrasion protection, skid resistance, decorative and astatic effects, photosensitive properties, UV protection, heat resistance and protection, and combinations and variations of these and other features. They have applications in coating that are organic, inorganic and combinations of these. They have applications in coatings that are porcelain, enamels, electroplated, to name a few others. They have applications in architectural coating, product coatings used by original equipment manufacturers (“OEM coatings”), special purpose coatings and other types of coatings. Architectural coatings would include for example paints and varnishes. Product coatings would include OEM coatings, industrial coatings, industrial finishes, boats, water craft, ships, after market coatings, and repair/refurbishing coatings, the products to which product coatings are applied is essentially endless, and would include for example automobiles, aircraft, appliances, wire, pipes, furniture, metal cans, chewing gum wrappers, packaging, equipment, etc. Specialty coatings would include for example, specialty coatings for cars, specialty marine coatings, stripping for highways, and others.

Boron-SiOC derived ceramic pigments have applications in coatings embodiments that contain a binder, volatile components, a pigment (which may be solely one or more polymer derived black ceramic pigments or combinations of the polymer derived black pigment and other pigments), and additives (noting that the polymer derived pigment, which may be other colors than black and preferably embodiments of boron-SiOC pigments, which may be other colors than black, can function as, or are, additives). These pigments are used with all types of resin, including acrylics, alkyds, amino, cellulosics, epoxies, polyesters, urethanes, poly(vinyl acetates), poly(vinyl chlorides), and others.

The boron-SiOC derived ceramic pigments can have surface properties and sizes such that they do not change the rheology of existing formulations that use other types of black pigments. In this manner they can be directly substituted for some, or all of the other type of pigment in a particular formulation without changing the rheology of that formulation and providing for example improved blackness and opacity. The nature of these pigments also provides the ability to have an embodiment of these pigments that provides functionality to control, modify, and regulate the rheology of a formulation. In this manner these pigments would have a dual role in the formulation as a pigment and as a rheology control additive.

Embodiments of coatings containing black boron-SiOC derived ceramic pigments provided enhanced abrasion resistance, e.g., the wearing away of a surface, and enhanced mar resistance, e.g., disturbances in the surface that alters its appearance. Abrasion and mar resistance would include resistance to scratching, gouging, wearing, and generally the resistance to the detrimental effects that occur when two surfaces are in sliding contact. Coatings using the black boron-SiOC derived ceramic pigments have abrasion resistance as measured by Taber Abrasion Tester (reported as number of mg of coating worn off after 1,000 cycles) of at most 30 mg, at most 150 mg, from about 10 mg to about 200 mg, and greater than 200 mg.

Embodiment of coatings containing black boron-SiOC derived ceramic pigments provided enhanced hardness. Hardness for coatings typically is measured by way of indentations, scratch, and pendulum tests. Hardness tests for coatings typically include an indentation test, the falling ball indentation Test (ASTM D-2394, which is well known to and available to the art, and the entire disclosure of which is incorporated herein by reference), a scratch test, the pencil hardness test (ASTM-D-3363-00, which is well known to and available to the art, and the entire disclosure of which is incorporated herein by reference), and a pendulum test, the Sward rocker (ASTM-2134-93), which is well known to and available to the art, and the entire disclosure of which is incorporated herein by reference).

Embodiment of Coatings using the black boron-SiOC derived ceramic pigments have indentation test results of at least 100 inch pounds at least 160 inch pounds, from about 50 to about 150 inch pounds, and greater than 160 inch pounds. Coatings using the black boron-SiOC derived ceramic pigments can have the same or better blackness, while having increases in indentation test results of at least about 50 inch pounds, at least about 160 inch pounds, and greater, when compared to a similar formulation using carbon black or metal oxides as the pigment.

Embodiments of coatings using the black boron-SiOC derived ceramic pigments have scratch test results of at least 7B pencil, at least F pencil, from about 8B pencil to about 6H pencil, and greater than 6H pencil. Coatings using the black boron-SiOC derived ceramic pigments can have the same or better blackness, while having increases in scratch test results of at least about 7B pencil, at least about F pencil, and greater, when compared to a similar formulation using carbon black or metal oxides as the pigment.

Embodiments of coatings using the black boron-SiOC derived ceramic pigments have pendulum test results of at least 20 oscillations at least 25 oscillations, from about 15 to about 55 oscillations, and greater than 56 oscillations. Coatings using the black boron-SiOC derived ceramic pigments can have the same or better blackness, while having increases in pendulum test results of at least about 20 oscillations, at least about 50 oscillations, and greater, when compared to a similar formulation using carbon black or metal oxides as the pigment.

The polymer derived black ceramic pigments, and preferably black boron-SiOC derived ceramic pigments can be used in formulations having UV stabilizers. These pigments do not diminish or adversely affect the UV stabilizing ability performance of the UV stabilizers. It is theorized that the boron-SiOC derived ceramic pigments may provide added UV stabilization to these UV stabilized formulations. The UV stabilizers can be UV absorbers, UV quenchers, and combinations of these. Typical UV stabilizes include, for example, 2-hydroxybenzophenones, 2-(2-hydroxyphenyl)-2H-benztriazoles, 2-(2-hydroxyphenyl)-4,6-phenyl-1,3,5-triazines, benzylidenemalonates, oxalanilides and others.

Typically, embodiments of the black boron-SiOC derived ceramic pigments can function as a UV absorber, and can be added to coatings to provide these function, thus function as both a additive and a pigment. Embodiments of a 3.0 μm D₅₀ black boron-SiOC derived ceramic pigment exhibit UV absorption (e.g., absorption coefficient, e.g., absorptivity) based upon the UV-vis data taken in diluted DI water solutions, set out in Table 1. The concentration of material is given in grams per 100 g of water (equivalently, g/100 mL). These concentrations gave a translucent solution.

TABLE 1
absorption coefficient

| | dB/cm/ | dB/cm/ | |
|---|---|---|---|
| concentration | concentration | concentration | dB/cm/concentration |
| (g/100 g) | @ 300 nm | @ 450 nm | @ 800 nm |
| 0.00952 | 3538.894732 | 3526.83657 | 3451.4463 |
| 0.02590 | 979.6193238 | 961.519095 | 946.46022 |

Generally, embodiments of the boron-SiOC derived ceramic pigment can have absorption coefficients of greater than 500 dB/cm/(g/100 g), greater than 5,000 dB/cm/(g/100 g), greater than 10,000 dB/cm/(g/100 g), from about 500 dB/cm/(g/100 g) to about 1,000 dB/cm/(g/100 g), from about 1,000 to about 5,000 dB/cm/(g/100 g), and from about 500 dB/cm/(g/100 g) to about 10,000 dB/cm/(g/100 g). In general, the smaller the pigments size, for the same pigment the higher will be the absorption coefficients.

The black boron-SiOC derived ceramic pigments can be used in formulations having antioxidants. These pigments do not diminish or adversely affect the anti-oxidizing performance of the antioxidants. These boron-SiOC derived ceramic pigments provide added anti-oxidation protection to these antioxidant containing formulations. Typical antioxidants include for example preventive antioxidants, peroxide decomposers, sulfides, phosphites, metal complex agents, and others.

The black boron-SiOC derived ceramic pigments can be used in formulations having hinder amine light stabilizers (“HALS”), which function to prevent the photo oxidative degradation of coatings. These pigments do not diminish or adversely affect the photo-oxidizing performance of the HALS. It is theorized that the boron-SiOC derived ceramic pigments may provide added photo-oxidation protection to these HALS containing formulations. Further, the black boron-SiOC derived ceramic pigments in some embodiments can be used to replace some, most, and all, of the HALS in the coating.

The black boron-SiOC derived ceramic pigments can be used in many types of coating or formulations, such as for example thermoplastic acrylic resins, thermosetting acrylic resins, hydroxy-functional acrylic resins, water reducible thermosetting acrylic resins, waterborne coatings (i.e., any coating with an aqueous media, e.g., latex coatings), water reducible coatings (i.e., a waterborne coating based on a resin having hydrophilic groups in most or all of its molecules), water soluble coatings (i.e., are soluble in water), latexes, acrylic latexes, vinyl ester latexes, thermosetting latexes, polyester resins, hydroxy-terminated polyester resins, amino resins, aminoplast resins, baked thermosetting coatings, melamine-formaldehyde resins (e.g., class I and class II), urea-formaldehyde resins, benzoguanamine-formaldehyde resins, glycoluril-formaldehyde resins, poly(meth)acrylamide-formaldehyde resins, polyurethane resins, two package solvent borne urethane coatings, epoxy resins, waterborne epoxy-amine systems, drying oil based resins, varnishes, alkyd resins, silicones, silicone rubber resins, and tetraethylorthosilicate (TEOS) based resins, among others.

The black boron-SiOC derived ceramic pigments can be used in many types of coating or formulations that utilize different types of solvents, such as for example, weak hydrogen-bonding solvents (e.g., aliphatic and aromatic hydrocarbons), hydrogen-bond acceptor solvents (e.g., esters and ketones) and hydrogen-bond donor-acceptor solvents (e.g., alcohols and propylene glycol).

In general, the smaller the particle size, the greater the fraction of light that will be absorbed by the same quantity, i.e., weight of particles. For pigments, and generally for embodiments of the black boron-SiOC derived ceramic pigments, the smaller the particle size of the pigment the greater the absorption of light.

The ability of a coating to hide the substrate, i.e., hiding, is a property that can be affected by many factors. Generally, hiding increases as film or coating thickness increases at the same pigment loading. Lower hiding coatings require thicker films. Also, hiding increases as pigment particle size decreases until a maximum hiding is reached and then hiding begins to decrease. Two coatings will hide the substrate the same, one with a lower pigment loading (of smaller particle size) and one with a higher pigment loading of a larger particle size. In general, embodiments of the black boron-SiOC derived ceramic pigments, provide higher hiding coatings, or hiding ability, for the same loading (e.g., weight of pigment to volume of coating) of black mixed metal oxide pigments and more quickly approach the hiding power of furnace carbon black.

TABLE 2

| Pigment | Particle | Pigment | |
|---|---|---|---|
| Type | size (micron) | loading to hiding | |
| Boron-SiOC | 2.5 to 3.5 | 1 lb/gallon to 1.5 lbs/gallon | |
| Boron-SiOC | 1.5 to 2.5 | 0.8 lbs/gallon to 1 lb/gallon | |
| Boron-SiOC | 1.0 to 1.5 | 0.7 to 0.8 | lbs/gallon |
| Boron-SiOC | 0.8 to 1.0 | 0.6 to 0.7 | lbs/gallon |
| Boron-SiOC | 0.6 to 0.8 | 0.55 to 0.60 | lbs/gallon |
| Boron-SiOC | 0.4 to 0.6 | 0.45 to 0.55 | lbs/gallon |
| Boron-SiOC | 0.2 to 0.4 | 0.35 to 0.45 | lbs/gallon |
| Boron-SiOC | 0.1 to 0.2 | 0.25 to 0.35 | lbs/gallon |
| Boron-SiOC | less than 0.1 | less than 0.25 | lbs/gallon |
| Cl Black 28 | about 0.5 | about 0.5 | lbs/gallon |
| Cl Black 26 | about 0.3 | about 0.3 | lbs/gallon |
| Thermal | 0.25 to 0.35 | about 0.4 | lbs/gallon |
| Carbon Black | | | |
| FurnaceCarbon | 0.03-0.05 | 0.1 to 0.2 | lbs/gallon |
| Black | | | |

Pigment loading to hiding is the required weight of pigment in a 50 micron dry film coating to cover a black and white substrate such that the eye cannot differentiate a difference in color over either colored background.

In general, in using the black boron-SiOC derived ceramic pigments, they can be formulated, mixed or made into a concentrated composition that can typically, although not necessarily, have other ingredients. These concentrated compositions are typically liquids, although not necessarily, they typically are call mill bases, dispersions, colorants, master-batches, and similar terms, which terms for the purposes of this specification, unless specifically stated otherwise, will be used to interchangeably. The present black ceramic pigments have excellent wettability, separation properties, and stability properties in both organic and aqueous media.

Polymer derived ceramic mill bases can contain one embodiment of the present boron-SiOC derived ceramic pigments, several different embodiments of the present ceramic pigments, other types of pigments, such as carbon black, and combinations and variations of these. When more than one pigment is present the mill base can be referred to as a composite grind, or composite grind mill base. Thus, for example, an embodiment of a polymer derived ceramic a composite grind mill base has a black boron-SiOC ceramic pigment and one or more of the following pigments: organic pigments, such as arylamide yellow (PY 73), diarylide yellow, barium red 2B toner (PR 48.1); polycyclic pigments, such as copper phthalocyanine, dioxanzine violet (PV 23), tetrachloro thiondigo (PR 88); inorganic pigments, such as carbon black, titanium dioxide, iron oxides, azurite, cadmium sulphides.

Although in embodiments of the present black ceramic pigments, dispersants are not needed or required, they may be added to either the mill base, or with the mill base at the time it is added to the coating formulation. Dispersants such as polymeric dispersants, A-B copolymer dispersants, hyperdispersants, superdispersants, and others may be used. In general dispersants function to stabilize the particle via either steric, electrosteric, or electrostatic means and can be non-ionic, anionic, cationic, or zwitterionic. Embodiments of dispersant structures can be linear polymers and copolymers, head-tail type modified polymers and copolymers, AB-block copolymers, ABA block copolymers, branched block copolymers, gradient copolymers, branched gradient copolymers, hyperbranched polymers and copolymers, star polymers and copolymers, and combinations and various of these and others.

It being understood that the mill base can be prepared and stored for later use, shipped, or used immediately. Further the step of making a mill base may be combined with, a part of, or otherwise incorporated into the process of formulation and making the coating. Generally in making a polymer derived ceramic pigmented coating three steps typically may be used—premixing, e.g., stirring the dry pigment into a liquid vehicle and eliminating any lumps; imparting shear stress to separate the pigment aggregates, which may be done in the presence of a dispersion stabilizer; and, letting down, which entails combining the pigment dispersion, e.g., mill base, with the remainder of the ingredients for the coating formulation. It being understood that some equipment is capable of performing only one or two of the steps, while other are capable of performing all three steps.

Equipment that may be used for forming the mill base can include, for example, high-speed disk dispersers, rotor-stator mixers, ball mills, basket mills, shot mills, hammer mills, media mills (e.g., sand mills, shot mills, bead mills), three roll mills, two roll mills, extruders, kneaders, internal batch mixers, such as banbury machines, extruders, ultrasound dispersers, and others.

The black boron-SiOC derived ceramic pigments can be used to make tinting pastes in this manner providing an embodiment of a polymer derived tinting paste. In general tinting paste will have a high loading of pigment to a small amount of resin so that a small amount of paste will give the maximum color. The black boron-SiOC derived ceramic pigments improve the tint strength as the particle size decreases. In general, tinting embodiments of the polymer derived black ceramic pigments, and preferably black boron-SiOC derived ceramic pigments, provide higher tinting strength in coatings, (less black pigment required to reach the same grey color with a lightness value between 72 and 75 on the CIELAB Lab scale, the lightness coming from a larger amount of TiO₂ white pigment which is tinted to a grey color by small additions of the black pigment). The smaller particle size boron-SiOC derived black ceramic pigment has higher tinting strength than black mixed metal oxide pigments and more quickly approaches the tinting strength of furnace carbon black. Tinting pastes can use multiple black additives, including boron-SiOC materials.

TABLE 3

| Pigment | Particle | Pigment | |
|---|---|---|---|
| Type | size (micron) | loading to light grey | |
| Boron-SiOC | 2.5 to 3.5 | 12 to 15 | parts |
| Boron-SiOC | 1.5 to 2.5 | 11 to 12 | parts |
| Boron-SiOC | 1.0 to 1.5 | 10 to 11 | parts |
| Boron-SiOC | 0.8 to 1.0 | 9 to 10 | parts |
| Boron-SiOC | 0.6 to 0.8 | 7.5 to 9 | parts |
| Boron-SiOC | 0.4 to 0.6 | 6.5 to 7.5 | parts |
| Boron-SiOC | 0.2 to 0.4 | 4.5 to 6.5 | parts |
| Boron-SiOC | 0.1 to 0.2 | 2.5 to 4.5 | parts |
| Boron-SiOC | less than 0.1 | less than 2.5 | parts |
| Cl Black 28 | about 0.5 | 7 to 8 | parts |
| Cl Black 26 | about 0.3 | 3.5 to 4.5 | parts |
| FurnaceCarbon | 0.03-0.05 | 1 | part |
| Black | | | |

### EXAMPLES

The following examples are provided to illustrate various embodiments of systems, processes, compositions, applications and materials of the present inventions. These examples are for illustrative purposes, may be prophetic, and should not be viewed as, and do not otherwise limit the scope of the present inventions.

### Example 1

Black boron-SiOC derived ceramic pigment is loaded at 5 pounds/gallon of a water-reducible acrylic resin having the composition of MMA/BA/HEMA/AA (where HEMA is 2-hydroxyethyl methacrylate, and AA is acrylic acid). The resin has a weight ratio for MMA:BA:HEMA:AA of 60:22.2:10:7.8.

### Example 2

Black boron-SiOC derived ceramic pigments of Example are loaded at 1.5 to 8 pounds/gallon of a water-reducible acrylic resin having the composition of MMA/BA/HEMA/AA (where HEMA is 2-hydroxyethyl methacrylate, and AA is acrylic acid). The resin has a weight ratio for MMA:BA:HEMA:AA of 60:22.2:10:7.8.

### Example 3

A very high temperature coating (VHTC) having a silicon based resin and having boron-SiOC ceramic pigment, size 0.25 μm, and a loading of 0.3 lbs/gal (23.97 g/L) has the following characteristics Good hiding power, excellent heat stability, jet black masstone, excellent UV stability and outdoor weather resistance, excellent humidity resistance, excellent corrosion resistance and hardness.

### Example 4

A very high temperature coating having a silicon based resin and having boron-SiOC ceramic pigment, size 0.5 μm, and a loading of 0.5 lbs/gal (59.91 g/L) has the following characteristics Good hiding power, excellent heat stability, jet black masstone, excellent UV stability and outdoor weather resistance, excellent humidity resistance, excellent corrosion resistance and hardness.

### Example 5

A very high temperature coating having a silicon based resin and having boron-SiOC ceramic pigment, size 0.1 μm, and a loading of 0.2 lbs/gal (11.83 g/L) has the following characteristics Good hiding power, excellent heat stability, jet black masstone, excellent UV stability and outdoor weather resistance, excellent humidity resistance, excellent corrosion resistance and hardness.

### Example 6

The VHTCs of Examples 1-5 are essentially free of heavy metals, having less than about 1 ppm Mn, Cr, or other heavy metals, having less than about 0.1 ppm Mn, Cr, or other heavy metals, having less than about 0.01 ppm Mn, Cr, or other heavy metals, less than about 0.001 ppm heavy metals, and having less than 0.0001 ppm heavy metals, and still more preferably being free from any detectable heavy metals, using standard and established testing methods know to the industry. The PDC pigments used in the formulations can have less than about 100 ppm heavy metals, less than about 10 ppm heavy metals, less than about 1 ppm heavy metals and less than about 0.1 heavy metals.

### Example 7

A high-solids acrylic enamel mill base having 25% solvent (butyl acetate), 20%≤0.2 μm boron-SiOC ceramic pigment, and 55% resin. The mill base is then added to an acrylic isocyanate base at a ratio of 1:3. The acrylic enamel is sprayed onto a metal substrate and exhibits the following features Gloss 20 degrees 95%, Gloss 60 degrees 99%, Color Development L 25, a 0, b −0.5

### Example 8

A boron-SiOC ceramic pigment is a colorant suitable and advantageous in multiple industrial, architectural, marine and automotive systems. The pigment is low dusting and easily disperses into acrylics, lacquers, alkyds, latex, polyurethane, phenolics, epoxies and waterborne systems providing a durable, uniform coating and pleasant aesthetic in both matte and gloss finishes. The boron-SiOC ceramic pigment has low oil absorption, which among other things, permits formulations to move to higher solids loading with lower VOC content. The pigment is substantially free, and preferably entirely free from heavy metals.

### Example 9

An embodiment of the boron-SiOC ceramic pigment is a colorant suitable and advantageous in multiple industrial settings and is non-conductive, acid, alkali resistant, and thermally stable up to 700° C., and 800° C. and 900° C. and 1000° C.

### Example 10

An embodiment of the boron-SiOC ceramic pigment, has added to the precursors a filler that provides conductivity to the pyrolized pigment, is a colorant suitable and advantageous in multiple industrial settings and is conductive, acid, alkali resistant, and thermally stable up to the melting temperature of the conductive filler.

### Example 11

The boron-SiOC ceramic pigment is added at sufficient levels to obtain the required coverage by the appliance manufacturer and applied to the interior of a microwave oven. The interior boron-SiOC pigment coating has good gloss, hiding and is non-arching during microwave use.

### Example 12

A boron-SiOC ceramic pigment has added to the precursor formulations carbon black. The pyrolized filled boron-SiOC pigment has the superior wettability and dispersion performance of the net boron-SiOC pigments, while having the cheaper carbon black material. The carbon black filler is a cheaper extender for the boron-SiOC material.

### Example 12a

The pigments of Example 12 have 20% carbon black filler.

### Example 13

A boron-SiOC formulation is cured to into the volumetric shape of a bead. The end cured boron-SiOC derived beads are, for example, added to paints, glues, plastics, and building materials, such as dry wall, sheet rock, gypsum board, MDF board, plywood, plastics and particleboard. The end cured boron-SiOC derived beads, as additives, can provide, among other things, binding (e.g., serve as a binder), water resistivity, fire resistance, fire retardation, fire protection and strength; as well as, abrasion resistance, wear resistance, corrosion resistance and UV resistance, if located at or near the surface of the shape.

### Example 13a

In addition to a beads of Example 13, the boron-SiOC additives can be in the form of a fine powder, fines, a power or other dispersible forms. The dispersible form can be obtained by grinding or crushing larger cured structures. They also may be obtained through the curing process if done under conditions that cause the structure to fracture, crack or break during curing. These dispersible forms may also be obtained by other processing techniques, for example, spray curing or drying.

### Example 14

A boron-SiOC formulation is cured to into the volumetric shape of a bead. The beads are then pyrolized to for a boron-SiOC derived ceramic bead. The boron-SiOC derived ceramic beads are added, for example, to paints, glues, plastics, and building materials, such as dry wall, sheet rock, gypsum board, MDF board, plywood, plastics and particleboard. The ceramic boron-SiOC beads, as additives, can provide, among other things, fire resistance, fire retardation, fire protection and strength.

In addition to a bead the boron-SiOC additives can be in the form of a fine power, fines, a power or other dispersible forms. The dispersible form can be obtained by grinding or crushing larger cured or pyrolized structures. They also may be obtained through the curing or pyrolysis process if done under conditions that cause the structure to fracture, crack or break during curing or pyrolysis.

### Example 15

A boron-SiOC formulation is pyrolized in the form of a volumetric structure. The ceramic boron-SiOC derived volumetric structure exhibits reflective and refractive optical properties, such as opalescence, shine, twinkle, and sparkle. These optical properties are present when the structure is black in color, (e.g., no colorant has been added to the formulation); or if the structure is colored (e.g., any color other than black, e.g., white, yellow, red, etc.).

Exhibit 16

The volumetric structures of Example 15 are small beads that are black and exhibit a twinkle, opalescence or shin. These beads are incorporated into a paint formulation. The patent formulation is for example applied to automobiles or appliances. It provides a flat or matte finish, which is for example popular on newer BMWs and Mercedes, but adds to that matte finish an inner sparkle or luster. Thus, the polysiloxane based paint formulation provides a sparkle matte finish to an automobile, appliance or other article.

### Example 17

Pyrolized boron-SiOC beads having a size of from about 100 to about 1,000 microns are added to a paint formulation at a loading of from about 1% to about 40%.

### Example 18

The paint of Example 17 in which the paint formulation, is an automotive paint, and is colored blue and the beads are the same blue color as the paint, and have size of 350 microns (+/−5%) and a loading of about 25%.

### Example 19

The paint of Example 17 in which the beads are not colored, i.e., they are black, and have a size ranging from about 300-500 microns, and the paint is a black, although not necessarily the same black as the beads.

### Example 20

A latex paint formulation having pyrolized boron-SiOC power added into the formulation, the power has a size range of about 0.5-100 microns, and the powder has a loading of about 15%.

### Example 21

The paint formulation of Example 19 is an enamel.

### Example 22

The boron-SiOC ceramic pigments can be made from the pyrolysis of any boron-SiOC batches that are capable of being pyrolized. The boron-SiOC pigment material can be provided, for example, as beads, powder, flakes, fines, or other forms that are capable of being dispersed or suspended in the paint formulation (e.g., platelets, spheres, crescents, angular, blocky, irregular or amorphous shapes). Beads can have a size of from about 100 to about 1,000 microns in diameter. Powders can have a particle size range of from about 0.5 to about 100 microns in diameter. Any subset range within these ranges can create the desired effect or color. Larger and smaller sizes may also provide the desired effects in other formulations. For example: 300-500 micron range beads; 350 (+/−5%) micron beads; 5-15 micron range powder. Particle size ranges for a particular boron-SiOC ceramic pigment preferably range as tight as +/−10% and more preferably +/−5%. The range may also be broader in certain applications, e.g., 100-1000 for beads, and e.g., 0.5-100 for powders. The density and hardness of the boron-SiOC ceramic pigment can be varied, controlled and predetermined by the precursor formulations used, as well as the curing and pyrolizing conditions. The boron-SiOC ceramic pigments provide enhanced corrosion resistance, scratch resistance and color (UV) stability to paint formulations. Optical properties or effects of the boron-SiOC ceramic pigment can, among other ways, be controlled by the use of different gases and gas mixtures, as well as other curing and pyrolysis conditions. The boron-SiOC ceramic pigment loading can be used anywhere from a 1% to a 40% in order to achieve the desired effect. Further, the use of the boron-SiOC ceramic pigments can provide enhanced flame retardant benefits. The boron-SiOC ceramic pigments have a further advantage of being low dusting, and easily mixed into any type of paint formulations, e.g., latex, enamel, polyurethanes, automotive OEM and refinish, alkyd, waterborne, acrylic and polyol coatings formulations. The boron-SiOC ceramic pigments can also be used as a fine colorant in inks and graphic arts formulations.

### Example 23

A ceramic ink comprising 10-30% boron-SiOC black ceramic pigment, 10-60% zinc or bismuth submicron glass frit, 10-20% Sucrose acetate isobutyrate, 4-15% hydrocarbon resin, 5-15% ethylene glycol.

### Example 24

A packaging ink comprising 2-30% boron-SiOC black ceramic pigment, 5-15% nitrocellulose resin, 25-35% ethanol solvent, 10-20% ethyl acetate solvent, 1-2% citrate plasticizer, 1% polyethylene wax solution, 5-10% additives.

### Example 25

A plastic comprising of 75-80% Polypropylene copolymer, 1-6% boron-SiOC black ceramic pigment, 15-20% talc

### Example 26

A plastic comprising of 94-98% HDPE plastic and 2-6% boron-SiOC black ceramic pigment

### Example 27

A plastic comprising 94-98% polycarbonate and 2-6% boron-SiOC black ceramic pigment

### Example 28

A plastic comprising 94-99% polyamide and 1-6% boron-SiOC black pigment

### Example 29

A rubber comprising of 55-65% EPDM elastomer, 10-40% boron-SiOC black ceramic pigment, 5-10% paraffinic extender oil, 3% zinc oxide, 0.5% stearic acid, 0.9% sulfur, 0.9% tetramethyl thiuram monosulphide, 0.5% antioxidant, 0.3% mercaptobenzothiazole.

### Example 30

A rubber based on 60-70% Fluoroelastomer, 10-20% boron-SiOC black ceramic pigment, 1-2% dimethyl-di (t-butyl peroxy)hexane, 1-1.5% triallyl iscocyanurate, 1-1.5% Zinc oxide.

### Example 31

A plastic comprising 75-80% ABS plastic, 2-6% boron-SiOC black ceramic pigment, 15-20% talc.

### Example 32

A phenolic molding compound comprising 50% phenolic resin, 35-45% talc, 5-15% boron-SiOC black ceramic pigment.

### Example 44

A Thermoplastic olefin compound comprising 60% polypropylene copolymer, 10-15% polyolefin elastomer, 2-6% boron-SiOC black ceramic pigment, 10% talc, 0.2% antioxidant.

### Example 34

A siloxane compound comprising 75-95% siloxane, 1-18% fumed silica, and 1-5% boron-SiOC black ceramic pigment.

### Example 35

A siloxane compound comprising 50-80% siloxane, 1-20% fumed silica, 1-20% talc or other white filler, and 0.5-5% boron-SiOC black pigment.

### Example 36

A lawnmower piston assembly made from A phenolic molding compound comprising 50% phenolic resin, 35-45% talc, 5-15% boron-SiOC black ceramic pigment.

### Example 37

A car dashboard made from a plastic comprising of 75-80% Polypropylene copolymer, 1-6% boron-SiOC black ceramic pigment, 15-20% talc.

### Example 38

A car bumper made from a thermoplastic olefin compound having 60% polypropylene copolymer, 10-15% polyolefin elastomer, 2-6% boron-SiOC black ceramic pigment, 10% talc, 0.2% antioxidant

### Example 39

A high temperature stable pump housing coating having 30-35% silicone resin, 8-30% micronized mica filler, 1-15% boron-SiOC black ceramic pigment, 35-50% xylene solvent.

### Example 40

An adhesive comprising 7-10% chlorinated rubber, 5-7% boron-SiOC ceramic black pigment, 4-5% phenol formaldehyde resin, 1-2% fumed silica, 1-2% zinc oxide, 50-6-% methyl ethyl ketone solvent, 5-10% xylene solvent.

### Example 41

Mill bases using the pigment of Examples 1, 2, 8, 10 and 12 are made. The mill bases have a thermoplastic acrylic polyol resin, a solvent Methyl amyl ketone and has a pigment loading of 1.5 to 6.0 pounds per gallon. The mill bases exhibits Newtonian flow characteristics.

### Example 42

Mill bases using the pigment of Examples 2-4, 5, 6, 11, and 13 are made. The mill bases have a thermoplastic acrylic polyol resin, a solvent Methyl Amyl ketone and has a pigment loading of 1.5 to 6.0 pounds/gallon. The mill bases exhibits Newtonian flow characteristics.

### Example 43

Mill bases using the pigment of Examples 1, 13, 14, 16 and 23 are made. The mill bases have a thermoplastic acrylic polyol resin, a solvent methyl amyl ketone and has a pigment loading of 1.5 to 6.0 pounds per gallon. The mill bases exhibits Newtonian flow characteristics.

### Example 44

A mill base using any of the pigments of Examples 1 to 31 is made. The mill base has a thermoplastic acrylic polyol resin, a solvent methyl amyl ketone and has a pigment loading of 1.5 to 6.0 pounds/gallon.

### Example 36

Mill bases using the pigment of Examples 1, 2, 8, 10 and 12 are made. The mill bases have a thermoplastic acrylic emulsion, a solvent water and has a pigment loading of 1.5 to 6 pounds/gallon

### Example 45

Mill bases using the pigment of Examples 1, 2, 8, 10 and 12 are made. The mill bases have a low molecular weight Bisphenol A diglycidal ether resin, a solvent xylene, and has a pigment loading of 1.5 to 6.0 pounds/gallon

### Example 46

Mill bases using the pigment of Examples 1, 2, 8, 10 and 12 are made. The mill bases have a modified hydroxyl ethyl cellulose, surfactant, and water and has a pigment loading of 1.5 to 8.0 pounds/gallon

### Example 47

Mill bases using the pigment of Examples 1, 2, 8, 10 and 12 are made. The mill bases have a silicone resin, a solvent xylene and has a pigment loading of 1.5 to 5.0 pounds/gallon

### Example 48

Mill bases using the pigment of Examples 1, 2, 8, 10 and 12 are made. The mill bases have a mineral oil based resin, a solvent mineral spirits and has a pigment loading of 1.5 to 8 pounds/gallon.

### Example 49

Mill bases using the pigment of Examples 1, 2, 8, 10 and 12 are made. The mill bases have a mineral oil based resin, a solvent mineral spirits and has a pigment loading of 2 pounds/gallon.

### Example 50

Black polysilocarb derived ceramic pigment is loaded at 1 g/Kg of a thermoplastic acrylic resin having the composition of S/MMA/BA/HEA (where S is styrene, MMA is methyl methacrylate, BA is n-butyl acrylate, and HEA is 2-hydroxyethyl acrylate). The resin has a weight ratio for S:MMA:BA:HEA of 15:14:40:30.

### Example 51

Black polysilocarb derived ceramic pigment is loaded at 30 g/Kg of a thermoplastic acrylic resin having the composition of S/MMA/BA/HEA (where S is styrene, MMA is methyl methacrylate, BA is n-butyl acrylate, and HEA is 2-hydroxyethyl acrylate). The resin has a weight ratio for S:MMA:BA:HEA of 15:14:40:30.

### Example 52

Black polysilocarb derived ceramic pigment is loaded at 100 g/Kg of a thermoplastic acrylic resin having the composition of S/MMA/BA/HEA (where S is styrene, MMA is methyl methacrylate, BA is n-butyl acrylate, and HEA is 2-hydroxyethyl acrylate). The resin has a weight ratio for S:MMA:BA:HEA of 15:14:40:30.

### Example 53

Black polysilocarb derived ceramic pigments of Example 1-6, 8 10, and 12 are loaded at 6 pounds/gallon of a water-reducible acrylic resin having the composition of MMA/BA/HEMA/AA (where HEMA is 2-hydroxyethyl methacrylate, and AA is acrylic acid). The resin has a weight ratio for MMA:BA:HEMA:AA of 60:22.2:10:7.8.

### Example 54

Example of a 500 g batch. 271.6 gram vinyl trimethoxysilane, 123.2 gram DCPD and 1.2 gram AIBN are charged to a flat-bottom reactor vessel under N2 purge. Seal the reactor, turn on coolant for condenser and mix the above chemicals at 100 RPM. React at 60-80° C. for 3 hrs and continue heating the liquid under reflux condition at 70-80° C. for 2 hrs. Open the reactor vessel, remove the cap after charge 110.9 gram of boric acid powder to the vessel and maintain the liquid temperature above 70° C. for at least 30 min to 1 hr to drive off excess methanol. Maintain the liquid mixture temperature at 70-85° C. and continue reaction for 1-2 hrs. The liquid poly borosiloxane resin is further cured after transferred to a oven set at 120° C. for at least 4-6 hrs to final curing and then followed by pyrolysis at temperatures between 950° C. to 1300° C.

### Example 55

85/15/5 MH/DCPD/TV materials with Boric Acid Powder (BAP) incorporated at two different concentrations: 20 wt % and 50 wt %. Curing reaction yield is ˜91-93%. Resulted materials are white soft foams. Pyrolysis were done in three ways: 1) direct pyrolysis of white foams; 2) further cure at 230° C. for 5 hrs in air followed by pyrolysis; 3) cure white foam material at 250° C. for 3 hrs in N2 followed by pyrolysis. Yield after pyrolysis is ˜80-85%.

The primary focus of the specification is on black pigment and additives. It should be understood, however, that other colors of polymer derived ceramic pigments and preferably boron-SiOC derived ceramic pigments can be utilized. These embodiments can have colorants, or fillers that impart different colors to the ceramic pigment. Such colorants can be for example glazes or other fillers or additives that maintain their color properties under pyrolysis conditions.

### Overview—Polysilocarb Formulations, Methods & Materials

Formulations, processes, methods of making, and compositions for various polysilocarbs are taught and disclosed in U.S. Pat. Nos. 9,499,677, 9,481,781 and US Patent Publication Nos. 2014/0274658, 2014/0323364, 2015/0175750, 2016/0207782, 2016/0280607, 2017/0050337, the entire disclosure of each of which are incorporated herein by reference.

General Processes for Obtaining a Polysilocarb Precursor

Typically, polymer derived ceramic precursor formulations, and in particular, polysilocarb precursor formulations, can generally be made by three types of processes, although other processes, and variations and combinations of these processes may be utilized. These processes generally involve combining precursors to form a precursor formulation. One type of process generally involves the mixing together of precursor materials in preferably a solvent free process with essentially no chemical reactions taking place, e.g., “the mixing process.” The other type of process generally involves chemical reactions, e.g., “the reaction type process,” to form specific, e.g., custom, precursor formulations, which could be monomers, dimers, trimers and polymers. A third type of process has a chemical reaction of two or more components in a solvent free environment, e.g., “the reaction blending type process.” Generally, in the mixing process essentially all, and preferably all, of the chemical reactions take place during subsequent processing, such as during curing, pyrolysis and both.

It should be understood that these terms—reaction type process, reaction blending type process, and the mixing type process—are used for convenience and as a short hand reference. These terms, i.e., process types, are not, and should not be viewed as, limiting. For example, the reaction type process can be used to create a precursor material that is then used in the mixing type process with another precursor material.

These process types are described in this specification, among other places, under their respective headings. It should be understood that the teachings for one process, under one heading, and the teachings for the other processes, under the other headings, can be applicable to each other, as well as, being applicable to other sections, embodiments and teachings in this specification, and vice versa. The starting or precursor materials for one type of process may be used in the other type of processes. Further, it should be understood that the processes described under these headings should be read in context with the entirely of this specification, including the various examples and embodiments.

It should be understood that combinations and variations of these processes may be used in reaching a precursor formulation, and in reaching intermediate, end, and final products. Depending upon the specific process and desired features of the product, the precursors and starting materials for one process type can be used in the other. A formulation from the mixing type process may be used as a precursor, or component in the reaction type process, or the reaction blending type process. Similarly, a formulation from the reaction type process may be used in the mixing type process and the reaction blending process. Similarly, a formulation from the reaction blending type process may be used in the mixing type process and the reaction type process. Thus, and preferably, the optimum performance and features from the other processes can be combined and utilized to provide a cost effective and efficient process and end product. These processes provide great flexibility to create custom features for intermediate, end, and final products, and thus, any of these processes, and combinations of them, can provide a specific predetermined product. In selecting which type of process is preferable, factors such as cost, controllability, shelf life, scale up, manufacturing ease, etc., can be considered.

The precursor formulations may be used to form a “neat” material (by “neat” material it is meant that all, and essentially all of the structure is made from the precursor material or unfilled formulation; and thus, for example, there are no fillers or reinforcements). The precursor formulations may be used to form a filled material, e.g., having an additive or other material in addition to the precursors. They may be used to form composite materials, e.g., structures or coatings having other materials such as reinforcements in them. They may be used to form non-reinforced materials, which are materials that are made of primarily, essentially, and preferably only from the precursor materials, e.g., minimally filled materials where the filler is not intended to add or enhance strength, and unfilled materials. They may be sued to form reinforced materials, for example materials having fibers or other materials to add strength, abrasion resistance, durability, or other features or properties, that generally are viewed as strength related in a broad sense.

In general, types of filler material include, for example: inert fillers, such as inorganic materials that do not react with the SiOC matrix during curing, pyrolysis or use; reactive fillers, such as zirconium, aluminum hydroxide, and boron compounds that react with the SiOC matrix during curing, pyrolysis, use, or combinations of these; and, active fillers, such as materials that are released during the use of the end product to provide specific features to that product, e.g., lubricant. A filler may come under more than one of these types.

The filler material may also be made from, or derived from the same material as the formulation that has been formed into a cured or pyrolized solid, or it may be made from a different precursor formulation material, which has been formed into a cured solid or semi-solid, or pyrolized solid.

The polysilocarb material (e.g., precursor batch, precursor, formulation, bulk liquid, etc.), can have various inhibitors, catalysts and initiator present that inhibit, regulate, or promote curing, under predetermined conditions. Thus, the polysilocarb coating material can have sufficient inhibitors present, or the absence of a catalyst, to provide the required shelf life for the material in storage.

The Mixing Type Process

Precursor materials may be a methyl hydrogen (methyl terminated hydride substituted polysiloxane), methyl hydrogen fluid (methyl terminated hydride methyl substitute polysiloxane, with little to no dimethyl groups) and substituted and modified methyl hydrogens, siloxane backbone materials, siloxane backbone additives, reactive monomers, reaction products of a siloxane backbone additive with a silane modifier or an organic modifier, and other similar types of materials, such as silane based materials, silazane based materials, carbosilane based materials, non-silicon based organic cross linkers, phenol/formaldehyde based materials, and combinations and variations of these. The precursors are preferably liquids at room temperature, although they may be solids that are melted, or that are soluble in one of the other precursors. (In this situation, however, it should be understood that when one precursor dissolves another, it is nevertheless not considered to be a “solvent” as that term is used with respect to the prior art processes that employ non-constituent solvents, e.g., solvents that do not form a part or component of the end product, are treated as waste products, and both.)

The precursors are mixed together in a vessel, preferably at room temperature. Preferably, little, and more preferably no solvents, e.g., water, organic solvents, polar solvents, non-polar solvents, hexane, THF, toluene, are added to this mixture of precursor materials. Preferably, each precursor material is miscible with the others, e.g., they can be mixed at any relative amounts, or in any proportions, and will not separate or precipitate. At this point the “precursor mixture” or “polysilocarb precursor formulation” is compete (noting that if only a single precursor is used the material would simply be a “polysilocarb precursor” or a “polysilocarb precursor formulation” or a “formulation”). Although complete, fillers and reinforcers may be added to the formulation. In preferred embodiments of the formulation, essentially no, and more preferably no chemical reactions, e.g., crosslinking or polymerization, takes place within the formulation, when the formulation is mixed, or when the formulation is being held in a vessel, on a prepreg, or over a time period, prior to being cured.

The precursors can be mixed under numerous types of atmospheres and conditions, e.g., air, inert, N₂, Argon, flowing gas, static gas, reduced pressure, elevated pressure, ambient pressure, and combinations and variations of these.

A catalyst or initiator may be used, and can be added at the time of, prior to, shortly before, or at an earlier time before the precursor formulation is formed or made into a structure, prior to curing. The catalysis assists in, advances, and promotes the curing of the precursor formulation to form a cured material or structure.

In this mixing type process for making a precursor formulation, preferably chemical reactions or molecular rearrangements only take place during the making of the raw starting materials, the curing process, and in the pyrolizing process. Preferably, in the embodiments of these mixing type of formulations and processes, polymerization, crosslinking or other chemical reactions take place primarily, preferably essentially, and more preferably solely during the curing process.

The precursor may be a methyl terminated hydride substituted polysiloxane, which can be referred to herein as methyl hydrogen (MH), having the formula shown below.

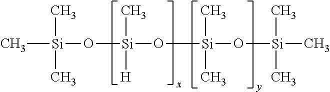

The MH, for example, may have a molecular weight (“mw” which can be measured as weight averaged molecular weight in amu or as g/mol) from about 400 mw to about 10,000 mw, from about 600 mw to about 3,000 mw, and may have a viscosity preferably from about 20 cps to about 60 cps. The percentage of methylsiloxane units “X” may be from 1% to 100%. The percentage of the dimethylsiloxane units “Y” may be from 0% to 99%. This precursor may be used to provide the backbone of the cross-linked structures, as well as, other features and characteristics to the cured preform and ceramic material. This precursor may also, among other things, be modified by reacting with unsaturated carbon compounds to produce new, or additional, precursors. Typically, methyl hydrogen fluid (MHF) has minimal amounts of “Y”, and more preferably “Y” is for all practical purposes zero.

The precursor may be any other linear siloxane backbone materials.

A variety of cyclosiloxanes can be used as precursors, and are reactive molecules, in the formulation. They can be described by the following nomenclature system or formula: DₓD*_{y}, where “D” represents a dimethyl siloxy unit and “D*” represents a substituted methyl siloxy unit, where the “*” group could be vinyl, allyl, hydride, hydroxy, phenyl, styryl, alkyl, cyclopentadienyl, or other organic group, x is from 0-8, y is >=1, and x+y is from 3-8. Further, in this nomenclature system—D represents —SiO₂ groups, typically Me₂SiO₂, Q represents SiO₄, T represents —SiO₃ groups, typically MeSiO₃ and M represent —SiO groups, typically Me₃SiO.

The precursor batch may also: (i) contain non-silicon based precursors, such as non-silicon based cross-linking agents; (ii) be the reaction product of a non-silicon based cross linking agent and a silicon based precursor; and, (iii) combinations and variation of these. The non-silicon based cross-linking agents are intended to, and provide, the capability to cross-link during curing. For example, non-silicon based cross-linking agents include: cyclopentadiene (CP), methylcyclopentadiene (MeCP), dicyclopentadiene (DCPD), methyldicyclopentadiene (MeDCPD), tricyclopentadiene (TCPD), piperylene, divnylbenzene, isoprene, norbornadiene, vinylnorbornene, propenylnorbornene, isopropenylnorbornene, methylvinylnorbornene, bicyclononadiene, methylbicyclononadiene, propadiene, 4-vinylcyclohexene, 1,3-heptadiene, cycloheptadiene, 1,3-butadiene, cyclooctadiene and isomers thereof. Generally, any hydrocarbon that contains two (or more) unsaturated, C═C, bonds that can react with a Si—H, or other Si bond in a precursor, can be used as a cross-linking agent. Some organic materials containing oxygen, nitrogen, and sulphur may also function as cross-linking agents.

The amount of the non-silicon based cross-linking agent to the silicon based precursor can be from about 10% to 90% non-silicon based cross-linker to 10% to 90% silicon based precursor (preferably a silicon backbone, e.g., —Si—O— backbone, material). Thus, the ranges of amounts can be, for example: DCPD/MHF from 10/90 to 90/10, about 40/60 to 60/40, about 50/50, and combinations and variations of these ratios, as well as other ratios. A third and fourth precursor material may also be used. Thus, the ratio of non-silicon cross linker/silicon backbone precursor/third precursor, can be: form about 10% to about 80% non-silicon based cross linker; from about 10% to 80% silicon based precursor: and form about 0.1% to 40% third precursor. The ranges and amounts can be, for example: DCPD/MHF/3^{rd} precursor from about 10/20/70 to 70/20/10, from about 10/20/70 to 10/70/20, from about 45/55/10 to about 55/45/10, from about 40/55/5 to about 55/40/5 and combinations and variations of these ratios as well as other ratios.

The precursor may be a reactive monomer. These would include molecules, such as tetramethyltetravinylcyclotetrasiloxane (TV), which formula is shown below.

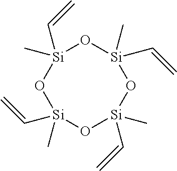 [SMILES: C=C[Si]1(C)O[Si](C)(C=C)O[Si](C)(C=C)O[Si](C)(C=C)O1]

This precursor may be used to provide a branching agent, a three-dimensional cross-linking agent, as well as, other features and characteristics to the cured preform and ceramic material. (It is also noted that in certain formulations, e.g., above 2%, and certain temperatures, e.g., about from about room temperature to about 60° C., this precursor may act as an inhibitor to cross-linking, e.g., in may inhibit the cross-linking of hydride and vinyl groups.)

The precursor may be a reactive monomer, for example, such as trivinyl cyclotetrasiloxane,

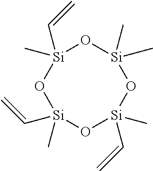 [SMILES: C=C[Si]1(C)O[Si](C)(C)O[Si](C)(C=C)O[Si](C)(C=C)O1]

Divinyl cyclotetrasiloxane,

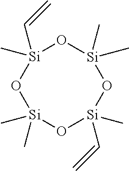

trivinyl monohydride cyclotetrasiloxane,

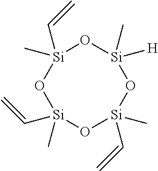 [SMILES: C=C[Si]1(C)O[SiH](C)O[Si](C)(C=C)O[Si](C)(C=C)O1]

divinyl dihydride cyclotetrasiloxane,

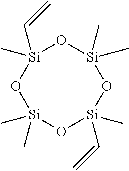

and a hexamethyl cyclotetrasiloxane, such as,

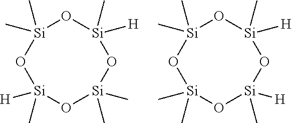

The precursor may be a silane modifier, such as vinyl phenyl methylsilane, diphenylsilane, diphenylmethylsilane, and phenylmethylsilane (some of which may be used as an end capper or end termination group). These silane modifiers can provide chain extenders and branching agents.

Thus, in additional to the forgoing type of precursors, it is contemplated that a precursor may be a compound of the following general formula.

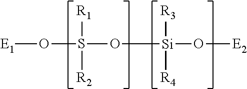

Wherein end cappers E₁ and E₂ are chosen from groups such as trimethylsilyl (trimethyl silicon) (—Si(CH₃)₃), dimethylsilyl hydroxy (dimethyl silicon hydroxy) (—Si(CH₃)₂OH), dimethylhydridosilyl (dimethyl silicon hydride) (—Si(CH₃)₂H), dimethylvinylsilyl (dimethyl vinyl silicon) (—Si(CH₃)₂(CH═CH₂)), dimethylphenylsilyl (—Si(CH₃)₂(C₆H₅)) and dimethylalkoxysilyl (dimethyl alkoxy silicon) (—Si(CH₃)₂(OR). The R groups R₁, R₂, R₃, and R₄ may all be different, or one or more may be the same. Thus, for example, R₂ is the same as R₃, R₃ is the same as R₄, R₁ and R₂ are different with R₃ and R₄ being the same, etc. The R groups are chosen from groups such as hydride (—H), methyl (Me)(—C), ethyl (—C—C), vinyl (—C═C), alkyl (—R)(CₙH₂ₙ₊₁), allyl (—C—C═C), aryl (‘R), phenyl (Ph)(—C₆H₅), methoxy (—O—C), ethoxy (—O—C—C), siloxy (—O—Si—R₃), alkoxy (—O—R), hydroxy (—O—H), phenylethyl (—C—C—C₆H₅) and methyl, phenyl-ethyl (—C—C(—C)(—C₆H₅).

In general, embodiments of formulations for polysilocarb formulations may, for example, have from about 0% to 50% MHF, about 20% to about 99% MHF, about 0% to about 30% siloxane backbone material, about 20% to about 99% siloxane backbone materials, about 0% to about 70% reactive monomers, about 0% to about 95% TV, about 0% to about 70% non-silicon based cross linker, and, about 0% to about 90% reaction products of a siloxane backbone additives with a silane modifier or an organic modifier reaction product.

In mixing the formulations sufficient time should be used to permit the precursors to become effectively mixed and dispersed. Generally, mixing of about 15 minutes to an hour is sufficient. Typically, the precursor formulations are relatively, and essentially, shear insensitive, and thus the type of pumps or mixing are not critical. It is further noted that in higher viscosity formulations additional mixing time may be required. The temperature of the formulations, during mixing should preferably be kept below about 45° C., and preferably about 10° C. (It is noted that these mixing conditions are for the pre-catalyzed formulations.)

The Reaction Type Process

In the reaction type process, in general, a chemical reaction is used to combine one, two or more precursors, typically in the presence of a solvent, to form a precursor formulation that is essentially made up of a single polymer that can then be, catalyzed, cured and pyrolized. This process provides the ability to build custom precursor formulations that when cured can provide plastics having unique and desirable features. The cured materials can also be pyrolized to form ceramics having unique features. The reaction type process allows for the predetermined balancing of different types of functionality in the end product by selecting functional groups for incorporation into the polymer that makes up the precursor formulation, e.g., phenyls which typically are not used for ceramics but have benefits for providing high temperature capabilities for plastics, and styrene which typically does not provide high temperature features for plastics but provides benefits for ceramics.

In general a custom polymer for use as a precursor formulation is made by reacting precursors in a condensation reaction to form the polymer precursor formulation. This precursor formulation is then cured into a preform, i.e., plastic, cured solid or semi-solid material, through a hydrolysis reaction. The condensation reaction forms a polymer of the type shown below.

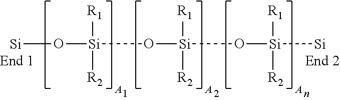

Where R₁ and R₂ in the polymeric units can be a hydride (—H), a methyl (Me)(—C), an ethyl (—C—C), a vinyl (—C═C), an alkyl (—R)(CₙH₂ₙ₊₁), an unsaturated alkyl (—CₙH₂ₙ₋₁), a cyclic alkyl (—CₙH₂ₙ₋₁), an allyl (—C—C═C), a butenyl (—C₄H₇), a pentenyl (—C₅H₉), a cyclopentenyl (—C₅H₇), a methyl cyclopentenyl (—C₅H₆(CH₃)), a norbornenyl (—C_{X}H_{Y}, where X=7-15 and Y=9-18), an aryl (‘R), a phenyl (Ph)(—C₆H₅), a cycloheptenyl (—C₇H₁₁), a cyclooctenyl (—C₈H₁₃), an ethoxy (—O—C—C), a siloxy (—O—Si—R₃), a methoxy (—O—C), an alkoxy, (—O—R), a hydroxy, (—O—H), a phenylethyl (—C—C—C₆H₅) a methyl, phenyl-ethyl (—C—C(—C)(—C₆H₅)) and a vinylphenyl-ethyl (—C—C(C₆H₄(—C═C))). R₁ and R₂ may be the same or different. The custom precursor polymers can have several different polymeric units, e.g., A₁, A₂, Aₙ, and may include as many as 10, 20 or more units, or it may contain only a single unit, for example, MHF made by the reaction process may have only a single unit.

Embodiments may include precursors, which include among others, a triethoxy methyl silane, a diethoxy methyl phenyl silane, a diethoxy methyl hydride silane, a diethoxy methyl vinyl silane, a dimethyl ethoxy vinyl silane, a diethoxy dimethyl silane. an ethoxy dimethyl phenyl silane, a diethoxy dihydride silane, a triethoxy phenyl silane, a diethoxy hydride trimethyl siloxane, a diethoxy methyl trimethyl siloxane, a trimethyl ethoxy silane, a diphenyl diethoxy silane, a dimethyl ethoxy hydride siloxane, and combinations and variations of these and other precursors, including other precursors set forth in this specification.

The end units, Si End 1 and Si End 2, can come from the precursors of dimethyl ethoxy vinyl silane, ethoxy dimethyl phenyl silane, and trimethyl ethoxy silane. Additionally, if the polymerization process is properly controlled a hydroxy end cap can be obtained from the precursors used to provide the repeating units of the polymer.

In general, the precursors are added to a vessel with ethanol (or other material to absorb heat, e.g., to provide thermal mass), an excess of water, and hydrochloric acid (or other proton source). This mixture is heated until it reaches its activation energy, after which the reaction typically is exothermic. Generally, in this reaction the water reacts with an ethoxy group of the silane of the precursor monomer, forming a hydroxy (with ethanol as the byproduct). Once formed this hydroxy becomes subject to reaction with an ethoxy group on the silicon of another precursor monomer, resulting in a polymerization reaction. This polymerization reaction is continued until the desired chain length(s) is built.

Control factors for determining chain length, among others, are: the monomers chosen (generally, the smaller the monomers the more that can be added before they begin to coil around and bond to themselves); the amount and point in the reaction where end cappers are introduced; and the amount of water and the rate of addition, among others. Thus, the chain lengths can be from about 180 mw (viscosity about 5 cps) to about 65,000 mw (viscosity of about 10,000 cps), greater than about 1000 mw, greater than about 10,000 mw, greater than about 50,000 mw and greater. Further, the polymerized precursor formulation may, and typically does, have polymers of different molecular weights, which can be predetermined to provide formulation, cured, and ceramic product performance features.

Upon completion of the polymerization reaction the material is transferred into a separation apparatus, e.g., a separation funnel, which has an amount of deionized water that, for example, is from about 1.2× to about 1.5× the mass of the material. This mixture is vigorously stirred for about less than 1 minute and preferably from about 5 to 30 seconds. Once stirred the material is allowed to settle and separate, which may take from about 1 to 2 hours. The polymer is the higher density material and is removed from the vessel. This removed polymer is then dried by either warming in a shallow tray at 90° C. for about two hours; or, preferably, is passed through a wiped film distillation apparatus, to remove any residual water and ethanol. Alternatively, sodium bicarbonate sufficient to buffer the aqueous layer to a pH of about 4 to about 7 is added. It is further understood that other, and commercial, manners of mixing, reacting and separating the polymer from the material may be employed.

Preferably a catalyst is used in the curing process of the polymer precursor formulations from the reaction type process. The same polymers, as used for curing the precursor formulations from the mixing type process can be used. It is noted that, generally unlike the mixing type formulations, a catalyst is not necessarily required to cure a reaction type polymer. Inhibitors may also be used. However, if a catalyst is not used, reaction time and rates will be slower. The curing and the pyrolysis of the cured material from the reaction process is essentially the same as the curing and pyrolysis of the cured material from the mixing process and the reaction blending process.

The reaction type process can be conducted under numerous types of atmospheres and conditions, e.g., air, inert, N₂, Argon, flowing gas, static gas, reduced pressure, ambient pressure, elevated pressure, and combinations and variations of these.

The Reaction Blending Type Process

In the reaction blending type process precursor are reacted to from a precursor formulation, in the absence of a solvent. For example, an embodiment of a reaction blending type process has a precursor formulation that is prepared from MHF and Dicyclopentadiene (DCPD). Using the reactive blending process a MHF/DCPD polymer is created and this polymer is used as a precursor formulation. It can be used alone to form a cured or pyrolized product, or as a precursor in the mixing or reaction processes.

Thus, for example, from about 40 to 90% MHF of known molecular weight and hydride equivalent mass; about 0.20 wt % P01 catalyst; and from about 10 to 60% DCPD with ≥83% purity, can be used.

P01 is a 2% Pt(0) tetravinylcyclotetrasiloxane complex in tetravinylcyclotetrasiloxane, diluted 20× with tetravinylcyclotetrasiloxane to 0.1% of Pt(0) complex. In this manner 10 ppm Pt is provided for every 1% loading of bulk cat.

In an embodiment of the process, a sealable reaction vessel, with a mixer, can be used for the reaction. The reaction is conducted in the sealed vessel, in air; although other types of atmosphere can be utilized. Preferably, the reaction is conducted at atmospheric pressure, but higher and lower pressures can be utilized. Additionally, the reaction blending type process can be conducted under numerous types of atmospheres and conditions, e.g., air, inert, N₂, Argon, flowing gas, static gas, reduced pressure, ambient pressure, elevated pressure, and combinations and variations of these.

In an embodiment, 850 grams of MHF (85% of total polymer mixture) is added to reaction vessel and heated to about 50° C. Once this temperature is reached the heater is turned off, and 0.20% (by weight of the MHF) of P01 Platinum catalyst is added to the MHF in the reaction vessel. Typically, upon addition of the catalyst, bubbles will form and temperature will initially rise approximately 2-20° C.

When the temperature begins to fall, about 150 g of DCPD (15 wt % of total polymer mixture) is added to the reaction vessel. The temperature may drop an additional amount, e.g., around 5-7° C.

At this point in the reaction process the temperature of the reaction vessel is controlled to, maintain a predetermined temperature profile over time, and to manage the temperature increase that may be accompanied by an exotherm. Preferably, the temperature of the reaction vessel is regulated, monitored and controlled throughout the process.

In an embodiment of the MHF/DCPD embodiment of the reaction process, the temperature profile can be as follows: let temperature reach about 80° C. (may take ˜15-40 min, depending upon the amount of materials present); temperature will then increase and peak at ˜104° C., as soon as temperature begins to drop, the heater set temperature is increased to 100° C. and the temperature of the reaction mixture is monitored to ensure the polymer temperature stays above 80° C. for a minimum total of about 2 hours and a maximum total of about 4 hours. After 2-4 hours above 80° C., the heater is turn off, and the polymer is cooled to ambient. It being understood that in larger and smaller batches, continuous, semi-continuous, and other type processes the temperature and time profile may be different.

Curing and Pyrolysis

Precursor formulations, including the polysilocarb precursor formulations from the above types of processes, as well as others, can be cured to form a solid, semi-sold, or plastic like material. Typically, the precursor formulations are spread, shaped, or otherwise formed into a preform, which would include any volumetric structure, or shape, including thin and thick films. In curing, the polysilocarb precursor formulation may be processed through an initial cure, to provide a partially cured material, which may also be referred to, for example, as a preform, green material, or green cure (not implying anything about the material's color). The green material may then be further cured. Thus, one or more curing steps may be used. The material may be “end cured,” i.e., being cured to that point at which the material has the necessary physical strength and other properties for its intended purpose. The amount of curing may be to a final cure (or “hard cure”), i.e., that point at which all, or essentially all, of the chemical reaction has stopped (as measured, for example, by the absence of reactive groups in the material, i.e., all of the reaction has stopped, or the leveling off of the decrease in reactive groups over time, i.e., essentially all of the reaction has stopped). Thus, the material may be cured to varying degrees, depending upon its intended use and purpose. For example, in some situations the end cure and the hard cure may be the same. Curing conditions such as atmosphere and temperature may effect the composition of the cured material.

In multi-layer, or composite structures and shapes, a layer of the polysilocarb material may be cured to varying degrees, for example in a multi-layer embodiment, the layers can be green cured to promote layer adhesion, then finally cured to a hard cure. Each layer in a multi-layer structure can be cured to the same degree of cure, to different degrees of cure, subject to one, two, three or more curing steps, and combinations and variations of these.

The curing may be done at standard ambient temperature and pressure (“SATP”, 1 atmosphere, 25° C.), at temperatures above or below that temperature, at pressures above or below that pressure, and over varying time periods. The curing can be conducted over various heatings, rate of heating, and temperature profiles (e.g., hold times and temperatures, continuous temperature change, cycled temperature change, e.g., heating followed by maintaining, cooling, reheating, etc.). The time for the curing can be from a few seconds (e.g., less than about 1 second, less than 5 seconds), to less than a minute, to minutes, to hours, to days (or potentially longer). The curing may also be conducted in any type of surrounding environment, including for example, gas, liquid, air, water, surfactant containing liquid, inert atmospheres, N₂, Argon, flowing gas (e.g., sweep gas), static gas, reduced O₂ (e.g., an amount of O₂ lower than atmospheric, such as less than 20% O₂, less than 15% O₂, less than 10% O₂ less than 5% O₂), reduced pressure (e.g., less than atmospheric), elevated pressure (e.g., greater than atmospheric), enriched O₂, (e.g., an amount of O₂ greater than atmospheric), ambient pressure, controlled partial pressure and combinations and variations of these and other processing conditions.

In an embodiment, the curing environment, e.g., the furnace, the atmosphere, the container and combinations and variations of these can have materials that contribute to or effect, for example, the composition, catalysis, stoichiometry, features, performance and combinations and variations of these in the preform, the cured material, the ceramic and the final applications or products.

For high purity materials, the furnace, containers, handling equipment, atmosphere, and other components of the curing apparatus and process are clean, essentially free from, and do not contribute any elements or materials, that would be considered impurities or contaminants, to the cured material.

Preferably, in embodiments of the curing process, the curing takes place at temperatures in the range of from about 5° C. or more, from about 20° C. to about 250° C., from about 20° C. to about 150° C., from about 75° C. to about 125° C., and from about 80° C. to 90° C. Although higher and lower temperatures and various heating profiles, (e.g., rate of temperature change over time (“ramp rate”, e.g., Δ degrees/time), hold times, and temperatures) can be utilized.

The cure conditions, e.g., temperature, time, ramp rate, may be dependent upon, and in some embodiments can be predetermined, in whole or in part, by the formulation to match, for example the size of the preform, the shape of the preform, or the mold holding the preform to prevent stress cracking, off gassing, or other phenomena associated with the curing process. Further, the curing conditions may be such as to take advantage of, preferably in a controlled manner, what may have previously been perceived as problems associated with the curing process. Thus, for example, off gassing may be used to create a foam material having either open or closed structure. Similarly, curing conditions can be used to create or control the microstructure and the nanostructure of the material. In general, the curing conditions can be used to affect, control or modify the kinetics and thermodynamics of the process, which can affect morphology, performance, features and functions, among other things.

Upon curing the polysilocarb precursor formulation a cross linking reaction takes place that provides in some embodiments a cross-linked structure having, among other things, by way of example, an —R₁—Si—C—C—Si—O—Si—C—C—Si—R₂— where R₁ and R₂ vary depending upon, and are based upon, the precursors used in the formulation. In an embodiment of the cured materials they may have a cross-linked structure having 3-coordinated silicon centers to another silicon atom, being separated by fewer than 5 atoms between silicon atoms. Although additional other structures and types of cured materials are contemplated. Thus, for example, use of Luperox 231 could yield a structure, from the same monomers, that was —Si—C—C—C—Si—. When other cross linking agents are used, e.g, DCPD and divinyl benzene, the number of carbons atoms between the silicon atoms will be greater than 5 atoms. A generalized formula for some embodiments of the cross-linked, e.g., cured, material, would be —Si—R₃—Si—, where R₃ would be ethyl (from for example a vinyl precursor), propyl (from for example a allyl precursor), dicyclopentane (from for example a DCPD precursor), norbornane (from for example a norbornadiene precursor), diethylbenzene (from for example a divinyl benzene precursor), and others.

During the curing process, some formulations may exhibit an exotherm, i.e., a self heating reaction, that can produce a small amount of heat to assist or drive the curing reaction, or that may produce a large amount of heat that may need to be managed and removed in order to avoid problems, such as stress fractures. During the cure off gassing typically occurs and results in a loss of material, which loss is defined generally by the amount of material remaining, e.g., cure yield. Embodiments of the formulations, cure conditions, and polysilocarb precursor formulations of embodiments of the present inventions can have cure yields of at least about 90%, about 92%, about 100%. In fact, with air cures the materials may have cure yields above 100%, e.g., about 101-105%, as a result of oxygen being absorbed from the air. Additionally, during curing the material typically shrinks, this shrinkage may be, depending upon the formulation, cure conditions, and the nature of the preform shape, and whether the preform is reinforced, filled, neat or unreinforced, from about 20%, less than 20%, less than about 15%, less than about 5%, less than about 1%, less than about 0.5%, less than about 0.25% and smaller.

Curing may be accomplished by any type of heating apparatus, or mechanisms, techniques, or morphologies that has the requisite level of temperature and environmental control. Curing may be accomplished through, for example, heated water baths, electric furnaces, microwaves, gas furnaces, furnaces, forced heated air, towers, spray drying, falling film reactors, fluidized bed reactors, indirect heating elements, direct heating (e.g., heated surfaces, drums, and plates), infrared heating, UV irradiation (light), an RF furnace, in-situ during emulsification via high shear mixing, in-situ during emulsification via ultrasonication, broad spectrum white light, IR light, coherent electromagnetic radiation (e.g. lasers, including visible, UV and IR), and convection heating, to name a few.

In an embodiment, curing may also occur under ambient conditions for an embodiment having a sufficient amount of catalyst.

If pyrolysis is conducted for an embodiment the cured material can be for example heated to about 600° C. to about 2,300° C.; from about 650° C. to about 1,200° C., from about 800° C. to about 1300° C., from about 900° C. to about 1,200° C. and from about 950° C. to 1,150° C. At these temperatures typically all organic structures are either removed or combined with the inorganic constituents to form a ceramic. Typically, at temperatures in the about 650° C. to 1,200° C. range the resulting material is an amorphous glassy ceramic. When heated above about 1,200° C. the material typically may from nano crystalline structures, or micro crystalline structures, such as SiC, Si3N₄, SiCN, β SiC, and above 1,900° C. an α SiC structure may form, and at and above 2,200° C. α SiC is typically formed. The pyrolized, e.g., ceramic materials can be single crystal, polycrystalline, amorphous, and combinations, variations and subgroups of these and other types of morphologies.

The pyrolysis may be conducted under may different heating and environmental conditions, which preferably include thermo control, kinetic control and combinations and variations of these, among other things. For example, the pyrolysis may have various heating ramp rates, heating cycles and environmental conditions. In some embodiments, the temperature may be raised, and held a predetermined temperature, to assist with known transitions (e.g., gassing, volatilization, molecular rearrangements, etc.) and then elevated to the next hold temperature corresponding to the next known transition. The pyrolysis may take place in reducing atmospheres, oxidative atmospheres, low O₂, gas rich (e.g., within or directly adjacent to a flame), inert, N₂, Argon, air, reduced pressure, ambient pressure, elevated pressure, flowing gas (e.g., sweep gas, having a flow rate for example of from about from about 15.0 GHSV (gas hourly space velocity) to about 0.1 GHSV, from about 6.3 GHSV to about 3.1 GHSV, and at about 3.9 GHSV), static gas, and combinations and variations of these.

In some embodiments, upon pyrolization, graphenic, graphitic, amorphous carbon structures and combinations and variations of these are present in the Si—O—C ceramic. A distribution of silicon species, consisting of SiOxCy structures, which result in SiO₄, SiO₃C, SiO₂C₂, SiOC₃, and SiC₄ are formed in varying ratios, arising from the precursor choice and their processing history. Carbon is generally bound between neighboring carbons and/or to a Silicon atom. In general, in the ceramic state, carbon is largely not coordinated to an oxygen atom, thus oxygen is largely coordinated to silicon

The pyrolysis may be conducted in any heating apparatus, that maintains the request temperature and environmental controls. Thus, for example pyrolysis may be done with, pressure furnaces, box furnaces, tube furnaces, crystal-growth furnaces, graphite box furnaces, arc melt furnaces, induction furnaces, kilns, MoSi₂ heating element furnaces, carbon furnaces, vacuum furnaces, gas fired furnaces, electric furnaces, direct heating, indirect heating, fluidized beds, RF furnaces, kilns, tunnel kilns, box kilns, shuttle kilns, coking type apparatus, lasers, microwaves, other electromagnetic radiation, and combinations and variations of these and other heating apparatus and systems that can obtain the request temperatures for pyrolysis.

In embodiments of the polysilocarb derived ceramic materials has any of the amounts of Si, O, C for the total amount of material that are set forth in the Table A. These percentages are with respect to Si O and C and do not take into consider the addition of B.

TABLE A

| | Si | | O | | C | |
|---|---|---|---|---|---|---|
| | Lo | Hi | Lo | Hi | Lo | Hi |
| Wt % | 35.00% | 50.00% | 10.00% | 35.00% | 5.00% | 30.00% |
| Mole Ratio | 1.000 | 1.429 | 0.502 | 1.755 | 0.334 | 2.004 |
| Mole % | 15.358% | 63.095% | 8.821% | 56.819% | 6.339% | 57.170% |

In general, embodiments of the pyrolized ceramic polysilocarb materials can have about 20% to about 65% Si, can have about 5% to about 50% O, and can have about 3% to about 55% carbon weight percent. Greater and lesser amounts are also contemplated. These percentages are with respect to Si O and C and do not take into consider the addition of B.

In general, embodiment of the pyrolized ceramic polysilocarb materials can have a mole ratio (based on total Si, O, and C) of about 0.5 to about 2.5 for Si, can have a mole ratio of about 0.2 to about 2.5 for O, and can have a mole ration of about 0.1 to about 4.5 for C. Greater and lesser amounts are also contemplated. These percentages are with respect to Si O and C and do not take into consider the addition of B.

In general, embodiment of the pyrolized ceramic polysilocarb materials can have a mole % (percentage of total Si, O, and C) of about 13% to about 68% for Si, can have a mole % of about 6% to about 60% for O, and can have a mole % of about 4% to about 75% for C. Greater and lesser amounts are also contemplated. These percentages are with respect to Si O and C and do not take into consider the addition of B.

The type of carbon present in embodiments of the polysilocarb derived ceramic pigments can be free carbon, (e.g., turbostratic, amorphous, graphenic, graphitic forms of carbon) and carbon that is bound to silicon. Embodiments of ceramic polysilocarb materials having free carbon and silicon-bound-carbon (Si—C) are set forth in Table B. Greater and lesser amounts and different percentages of free carbon and silicon-bound-carbon are also contemplated. These percentages are with respect to Si O and C and do not take into consider the addition of B.

TABLE B

| Embodiment | % Free Carbon | % Si—C type |
|---|---|---|
| 1 | 64.86 | 35.14 |
| 2 | 63.16 | 36.85 |
| 3 | 67.02 | 32.98 |
| 4 | 58.59 | 41.41 |
| 5 | 68.34 | 31.66 |
| 6 | 69.18 | 30.82 |
| 7 | 65.66 | 34.44 |
| 8 | 72.74 | 27.26 |
| 9 | 72.46 | 27.54 |
| 10 | 78.56 | 21.44 |

Generally, embodiments of polysilocarb derived ceramic materials can have from about 30% free carbon to about 70% free carbon, from about 20% free carbon to about 80% free carbon, and from about 10% free carbon to about 90% free carbon, and from about 30% Si—C bonded carbon to about 70% Si—C bonded carbon, from about 20% Si—C bonded carbon to about 80% Si—C bonded carbon, and from about 10% Si—C bonded carbon to about 90% Si—C bonded carbon. Greater and lesser amounts are also contemplated. These percentages are with respect to Si O and C and do not take into consider the addition of B.

### Headings and Embodiments

It should be understood that the use of headings in this specification is for the purpose of clarity, and is not limiting in any way. Thus, the processes and disclosures described under a heading should be read in context with the entirely of this specification, including the various examples. The use of headings in this specification should not limit the scope of protection afford the present inventions.

It is noted that there is no requirement to provide or address the theory underlying the novel and groundbreaking processes, materials, performance or other beneficial features and properties that are the subject of, or associated with, embodiments of the present inventions. Nevertheless, various theories are provided in this specification to further advance the art in this area. The theories put forth in this specification, and unless expressly stated otherwise, in no way limit, restrict or narrow the scope of protection to be afforded the claimed inventions. These theories many not be required or practiced to utilize the present inventions. It is further understood that the present inventions may lead to new, and heretofore unknown theories to explain the function-features of embodiments of the methods, articles, materials, devices and system of the present inventions; and such later developed theories shall not limit the scope of protection afforded the present inventions.

The various embodiments of formulations, compositions, articles, plastics, ceramics, materials, parts, uses, applications, equipment, methods, activities, and operations set forth in this specification may be used for various other fields and for various other activities, uses and embodiments. Additionally, these embodiments, for example, may be used with: existing systems, articles, compositions, plastics, ceramics, operations or activities; may be used with systems, articles, compositions, plastics, ceramics, operations or activities that may be developed in the future; and with such systems, articles, compositions, plastics, ceramics, operations or activities that may be modified, in-part, based on the teachings of this specification. Further, the various embodiments and examples set forth in this specification may be used with each other, in whole or in part, and in different and various combinations. Thus, for example, the configurations provided in the various embodiments and examples of this specification may be used with each other; and the scope of protection afforded the present inventions should not be limited to a particular embodiment, example, configuration or arrangement that is set forth in a particular embodiment, example, or in an embodiment in a particular FIGURE.

The invention may be embodied in other forms than those specifically disclosed herein without departing from its spirit or essential characteristics. The described embodiments are to be considered in all respects only as illustrative and not restrictive.

1. A high temperature black ceramic pigment comprising:
a. a ceramic matrix, the matrix consisting essentially of: silicon, oxygen, carbon and boron;
b. wherein the ceramic pigment has a black color defining a degree of blackness;
c. whereby when the pigment is exposed to a temperature of 1,000° F. for a period of 20 hours the degree of blackness does not change.

2. The pigment of claim 1, wherein the matrix is free from boric acid.

3. The pigment of claim 1, wherein the matrix is free from boron oxide.

4. The pigment of claim 1, wherein the matrix consists of silicon carbon oxygen and boron.

5. A high temperature black ceramic pigment comprising:
a. a ceramic matrix, the matrix comprising: silicon, oxygen, carbon and boron; and being free from boron oxide;
b. wherein the ceramic pigment has a black color defining a degree of blackness;
c. whereby when the pigment is exposed to a temperature of 1,000° F. for a period of 20 hours the degree of blackness does not change.

6. A high temperature black ceramic pigment comprising:
a. a ceramic matrix, the matrix comprising: silicon, oxygen, carbon and boron; and being free from boric acid;
b. wherein the ceramic pigment has a black color defining a degree of blackness;
c. whereby when the pigment is exposed to a temperature of 1,000° F. for a period of 20 hours the degree of blackness does not change.

7. The pigment of claim 6, wherein the matrix is free from boron oxide.

8. The pigment of claim 6, wherein the matrix defines and inner section of the pigment, having an outer surface; and a coating on the outer surface on the inner section of the pigment; the coating comprising boric acid, boron oxide or both.

9. The pigment of claim 1, wherein the matrix defines and inner section of the pigment, having an outer surface; and a coating on the outer surface on the inner section of the pigment; the coating comprising boron.

10. The pigment of claim 5, wherein the matrix comprises boron-spices selected from the group consisting of: BC, BC₂, and BC₃.

11. The pigment of claim 1, wherein the matrix comprises boron-spices selected from the group consisting of: B(OSi)₃, B (OSi)₂OB, B(OSi) OB₂, and BOSiBC₃.

12. The pigment of claim 1, wherein the matrix comprises boron-spices selected from the group consisting of: BOC₂, BCSi, BO₂C, BOCSi, and BCSi₂.

13. The pigment of claim 5, wherein the ceramic matrix has about 4-11.5% of incorporated Boron as an atomic percentage, about 36-55% of O as an atomic percentage, about 12.7-22.5% Si as an atomic percentage, and about 17-41% of C as an atomic percentage.

14. The pigment of claim 7, wherein the silicon, oxygen and carbon having from about 15.3 mole % to about 63.1 mole % silicon, from about 8.8 mole % to about 56.8 mole % oxygen, and at least about 6.3 mole % carbon, and wherein about 20 weight % to about 80 weight % of the carbon is silicon-bound-carbon and about 80 weight % to about 20 weight % of the carbon is free carbon

15. The pigment of claim 1, wherein the degree of blackness is selected from the group consisting of: PMS 433, Black 3, Black 3, Black 4, Black 5, Black 6, Black 7, Black 2 2×, Black 3 2×, Black 4 2×, Black 5 2×, Black 6 2×, and Black 7 2×.

16. The pigment of claim 7, wherein the degree of blackness is selected from the group consisting of: Tri-stimulus Colorimeter of X from about 0.05 to about 3.0, Y from about 0.05 to about 3.0, and Z from about 0.05 to about 3.0; a CIE L a b of L of less than about 40; a CIE L a b of L of less about 20; a CIE L a b of L of less than 50, b of less than 1.0 and a of less than 2; and a jetness value of at least about 200 M_{y}.

17. The pigment of claim 7, wherein when the pigment is exposed to a temperature of 1,000° F. for a period of 40 hours the degree of blackness does not change.

18. The pigment of claim 5, wherein when the pigment is exposed to a temperature of 1,000° F. for a period of 500 hours the degree of blackness does not change.

19. The pigment of claim 7, wherein when the pigment is exposed to a temperature of 1,200° F. for a period of 20 hours the degree of blackness does not change.

20. The pigment of claim 1, wherein when the pigment is exposed to a temperature of 1,200° F. for a period of 40 hours the degree of blackness does not change.

21. (canceled)
